(19) United States
(12) Patent Application Publication
(10) Pub. No.: US 2023/0229563 A1
(43) Pub. Date: Jul. 20, 2023

(54) METHOD, APPARATUS, AND COMPUTER READABLE MEDIUM FOR DYNAMIC SUBSTITUTION OF REPEATING TRANSFER DATA STRUCTURES USING A LINKED QUEUE

(71) Applicant: AGORA INTELLIGENCE, INC., Santa Clara, CA (US)

(72) Inventors: Kevin HOPKINS, Sandy, UT (US); John Gabriel BALLARD, San Jose, CA (US)

(21) Appl. No.: 18/097,918

(22) Filed: Jan. 17, 2023

Related U.S. Application Data
(60) Provisional application No. 63/299,801, filed on Jan. 14, 2022.
(60) Provisional application No. 63/338,352, filed on May 4, 2022.

(51) Int. Cl. G06F 11/14

(52) U.S. Cl. CPC G06F 11/1451; G06F 11/1464

(57) ABSTRACT

A method, apparatus, and computer-readable medium for dynamic substitution of repeating transfer data structures using a linked queue, the method including grouping repeating transfer data structures into a plurality of repeating transfer groups, identifying primary repeating transfers and backup repeating transfers in each repeating transfer group based on a utilization ratio, storing the primary repeating transfers in the plurality of repeating transfer groups in a memory and storing the backup repeating transfers in the plurality of repeating transfer groups in a plurality of backup queues in the memory, detecting failure of a primary repeating transfer in a first repeating transfer group, and in response to detecting failure of the primary repeating transfer, removing the failed primary repeating transfer from the first repeating transfer group and substituting a backup repeating transfer from a first backup queue corresponding to the first repeating transfer group and linked in the memory to the first repeating transfer group into the first repeating transfer group.

### RELATED APPLICATION DATA

This application claims priority to U.S. Provisional Patent Application No. 63/338,352 filed May 4, 2022, and to U.S. Provisional Patent Application No. 63/299,801 filed Jan. 14, 2022, the disclosures of which are hereby incorporated by reference in their entirety.

This application is also related to U.S. Provisional Application No. 63/075,513 filed Sep. 8, 2020, U.S. Provisional Application No. 63/218,189 filed Jul. 2, 2021, U.S. Nonprovisional application Ser. No. 17/469,510 filed Sep. 8, 2021, and U.S. Provisional Application No. 63/250,919 filed Sep. 30, 2021 (collectively referred to herein as “the Related Applications”) the disclosures of which are hereby incorporated by reference in their entirety.

### BACKGROUND

Repeating transfers, such as recurring receivables, frequently have too low of an associated value to be used in transfer and funding networks. In order to efficiently make use of repeating transfers in transfer networks, it is necessary group different repeating transfers. However, this grouping of repeating transfers raise significant technical challenges. No technological platform or infrastructure exists to facilitate such bundling of groups of repeating transfers. Additionally, even if such a bundling were possible, the failure or cancellation of any one repeating transfer in any group of repeating transfers would cause the entire group of repeating transfers to fail.

### BRIEF DESCRIPTION OF THE DRAWINGS

FIG. 1 illustrates a flowchart for a method of dynamic substitution of repeating transfer data structures using a linked queue according to an exemplary embodiment.

FIG. 2 illustrates an example of grouping a plurality of recurring receivables contracts into a plurality of MPGs according to an exemplary embodiment.

FIG. 3 illustrates another example of grouping a plurality of recurring receivables contracts into a plurality of MPGs according to an exemplary embodiment.

FIG. 4 illustrates an example of the step of filtering the plurality of MPGs to remove any MPGs having a quantity of recurring receivables contracts below a minimum threshold according to an exemplary embodiment.

FIG. 5 illustrates a flowchart for identifying a plurality of primary repeating transfer data structures and a plurality of backup repeating transfer data structures in each repeating transfer group based at least in part on a utilization ratio according to an exemplary embodiment.

FIG. 6 illustrates an example of identifying a plurality of fundable recurring receivables contracts and a plurality of non-fundable recurring receivables contracts in an MPG based at least in part on a funding ratio according to an exemplary embodiment.

FIG. 7 illustrates an example of identifying a plurality of fundable recurring receivables contracts and a plurality of non-fundable recurring receivables contracts in multiple MPGs based at least in part on a funding ratio according to an exemplary embodiment.

FIG. 8 illustrates an example of a fundable group and the corresponding non-fundable group in memory according to an exemplary embodiment.

FIGS. 9A-9D illustrate an example of contract cancellation and contract substitution according to an exemplary embodiment.

FIG. 10 illustrates a flowchart for determining a total proposed transfer quantity based at least in part on the remaining repeating transfer data structures in the plurality of primary groups according to an exemplary embodiment.

FIG. 11 illustrates an example of the steps of determining a total value of recurring receivables contracts for each fundable group in the plurality of fundable groups and determining a total funding amount for each fundable group in the plurality of fundable groups according to an exemplary embodiment.

FIG. 12 illustrates a flowchart for transferring one or more repeating transfer data structures in one or more primary groups in the plurality of primary groups from the one or more primary groups to one or more backup queues in the plurality of backup queues that are linked to the one or more primary groups based at least in part on a transfer exposure limit according to an exemplary embodiment.

FIG. 13 illustrates a flowchart in the invoice/receivables financing context for transferring the one or more recurring revenue contracts in the one or more fundable groups from the one or more fundable groups to the one or more non-fundable queues that are linked to the one or more fundable groups based at least in part on a determination that the aggregate total funding amount exceeds the funder exposure limit according to an exemplary embodiment.

FIG. 14 illustrates an example of transferring the one or more recurring revenue contracts in the one or more fundable groups from the one or more fundable groups to the one or more non-fundable queues that are linked to the one or more fundable groups based at least in part on a determination that the aggregate total funding amount exceeds the funder exposure limit according to an exemplary embodiment.

FIG. 15 illustrates the components of the specialized computing environment configured to perform the specialized processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

In the context of invoices/receivables, the term seller refers to a company that is selling services/products. The term buyer refers to a company named on the outstanding invoices/receivables that owes an outstanding balance to the seller, typically a customer of the seller. The term funder refers to a company or individual that provides funding to the seller on the basis of outstanding receivables/invoices. Additionally, as used herein, the term receivable includes invoices and the terms recurring receivables and recurring receivables contracts refer to periodic (e.g., monthly) bills due on a services or product contracts.

Invoice-based financing involves funders providing funds to sellers on the basis of invoices owed to the sellers from buyers. While many companies would benefit from invoice-based financing, it is difficult for many funders to obtain or leverage accurate information about buyer and seller companies in order to accurate determine risk and the appropriate level of commissions to charge for funding.

Another difficulty in implementing invoice-based financing relates specifically to repeating transfers, such as recurring receivables contracts. Individual businesses/sellers frequently receive revenue over a period of time (e.g., weekly, bi-weekly, monthly, bi-monthly, quarterly, etc.). Many of these businesses and sellers receive recurring revenue in small dollar amounts, making the invoices and recurring receivables unsuitable for invoice financing from funders who typically seeking returns on larger funding amounts.

Additionally, any attempt to bundle or group repeating transfers (e.g., recurring receivables) for financing would also raise significant technical challenges. No technological platform or infrastructure exists to facilitate such bundling, pricing, and financing of groups of recurring receivables contracts. Additionally, even if such a bundling were possible, the failure or cancellation of any one contract in any group of bundled recurring receivables contracts would cause the entire group of bundled contracts to fall below expected returns or otherwise fail.

Applicant has developed improvements in technology platforms for financing of repeating transfers such as recurring receivable contracts that enable bundling or grouping of repeating transfers and that include failsafe mechanisms to address the failure of any repeating transfer within bundles or groups of repeating transfers.

In particular, Applicant has discovered a method, apparatus, and computer-readable medium for grouping repeating transfers within a transfer network and dynamic substitution of repeating transfers using a linked queue. The present system not only encodes and groups repeating transfers, but also provides a linked backup system to maintain the group of repeating transfers in the event of failure of a repeating transfer.

In the invoice/recurring receivables context, the present system allows for bundling or grouping of recurring receivable contracts and including a failsafe mechanism to address the failure, cancellation, or default of recurring receivable contracts within groups or bundles and replacement of failed or cancelled contracts. As will be explained in greater detail below, the failsafe mechanism creates Monthly Payment Groups (MPGs) of similar contracts, separates MPGs into primary groups (for funding) and secondary groups (as backup to the primary groups). Secondary groups can be stored in a queue or other data structure and linked in memory to a corresponding primary group such that when a recurring receivable contract within the primary group is canceled or fails, a replacement contract from the secondary group can be substituted for the canceled or failed contract.

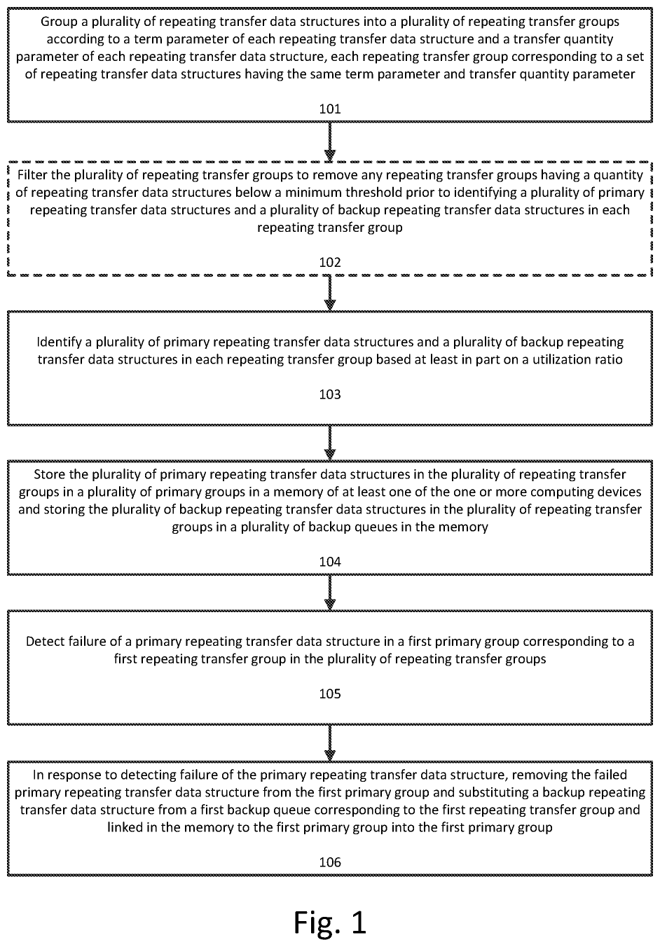

FIG. 1 illustrates a flowchart for a method of dynamic substitution of repeating transfer data structures using a linked queue according to an exemplary embodiment. Each of the steps in the method can be performed by a controller of a transfer network, the controller including one or more computing devices. The disclosed methods relate to dynamic substitution of repeating transfer data structures in any context, but several of the steps are described with respect to examples specific to the invoice/receivable financing context. In the invoice/receivable financing context, the disclosed method allows for dynamic substitution of recurring receivables contracts (also referred to as “contracts”) using a linked queue.

At step 101 a plurality of repeating transfer data structures are grouped into a plurality of repeating transfer groups according to a term parameter of each repeating transfer data structure and a transfer quantity parameter of each repeating transfer data structure. Each repeating transfer group corresponding to a set of repeating transfer data structures has the same term parameter and transfer quantity parameter.

In the invoice/receivable financing context, the repeating transfer data structures can correspond to recurring receivables contracts and the repeating transfer groups can correspond to Monthly Payment Groups (MPGs). The term parameter in this case is the contract term of each recurring receivables contract and the quantity parameter is the monthly payment amount of each recurring receivables contract. Therefore, at step 101 in the invoice/receivable financing context, a plurality of recurring receivables contracts are grouped into a plurality of Monthly Payment Groups (MPGs) according to a contract term of each recurring receivables contract and a monthly payment amount of each recurring receivables contract. Each MPG corresponds to a set of recurring receivables contracts having the same contract term and monthly payment amount.

The recurring receivables contracts are contracts between sellers of goods or services and buyers of those goods or services and can be contracts for goods or services to be provided, payment plans for goods or services previously provided, and/or any other type of financial arrangement between the buyer and seller for payments over a period of time.

The recurring receivables contracts can be encoded in the system as repeating transfer data structures, with various parameters corresponding to the contract terms and conditions. For example, a term parameter can store a contract term, a transfer quantity parameter can indicate a monthly payment amount, etc.

The contract term is the duration of the contract and can be defined in one or more of the following units of duration: monthly, bi-monthly, weekly, bi-weekly, daily, quarterly, or any other unit of time. The default unit of duration can be monthly and can be adjusted based on user, seller, and/or funder preferences.

The contract term can be any duration, such as, for example, a term in the range of 1 to 36 months. The default contract term can be set to 12 months, but can be adjusted up or down based upon the specific contracts in question.

Additionally, the monthly payment amount is only one example of a payment amount per unit time that can be used to group the contracts. The payment amount used to group the recurring receivables contracts can be a payment amount per any unit of duration, such as: a bi-monthly payment amount, a weekly payment amount, a bi-weekly payment amount, a daily payment amount, and/or a quarterly payment amount.

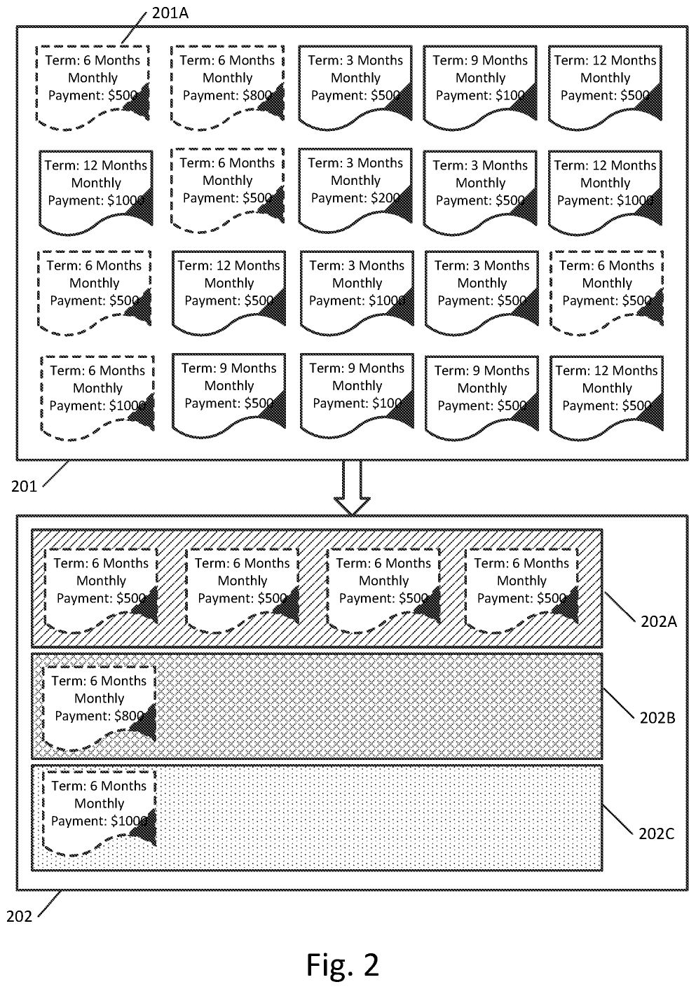

FIG. 2 illustrates an example of grouping a plurality of recurring receivables contracts into a plurality of MPGs according to an exemplary embodiment. Box 201 shows a plurality of recurring receivables contracts, including each contract's term and monthly payment amount. For example, recurring receivable contract 201A has a term of 6 months and a monthly payment amount of $500.

The contracts shown in box 201A are grouped into MPGs according to a contract term of each recurring receivables contract and monthly payment amount of each recurring receivables contract. Box 202 illustrates all of the recurring receivables contracts having a 6 month term (referred to as the 6 month “term group”). The contracts within the 6 month term group are shown in dashed outlines in box 201 and box 202. Within the term group, there are three MPGs, each MPG corresponding to a different monthly payment amount. This includes MPG 202A, corresponding to a monthly payment amount of $500 and having 4 contracts, MPG 202B, corresponding to a monthly payment amount of $800 and having 1 contract, and MPG 202C, corresponding to a monthly payment amount of $1000 and having 1 contract.

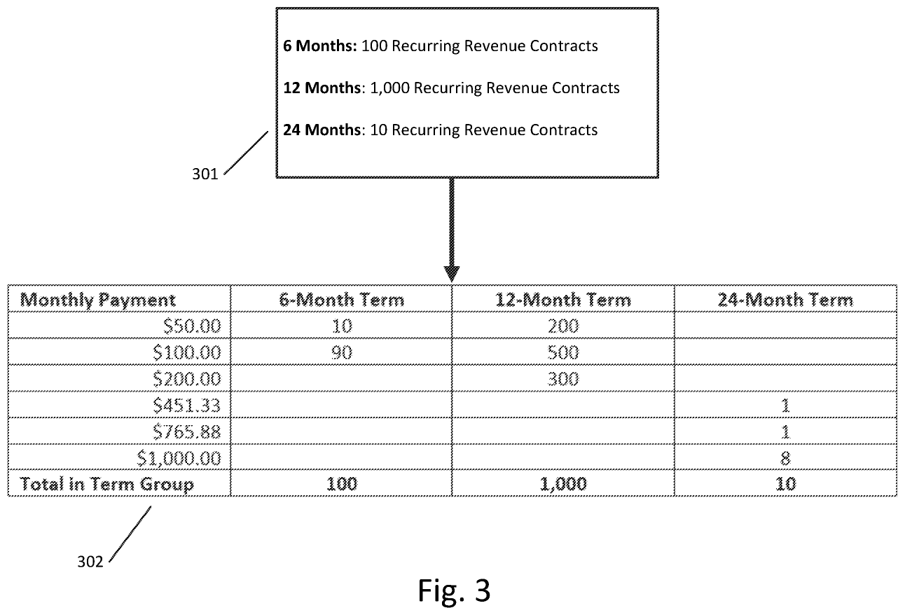

FIG. 3 illustrates another example of grouping a plurality of recurring receivables contracts into a plurality of MPGs according to an exemplary embodiment. As shown in box 301, the system receives and/or detects 100 recurring revenue contracts having a 6 month term, 1,000 recurring revenue contracts having a 12 month term, and 10 recurring revenue contracts having a 24 month term.

The MPGs formed by the grouping of the contracts in box 301 are shown in the rows of table 302. The cells in table 302 correspond to a different MPGs, with the columns corresponding to different term groups and the rows corresponding to different monthly payment groups. The value in each of the cells corresponding to MPGs indicates a quantity of contracts in those MPGs. For example, per table 302, there are 90 recurring receivables contracts in the MPG corresponding to a monthly payment amount of $100 and a contract term of 6 months. In another example, there are 300 recurring receivables contracts in the MPG corresponding to a monthly payment amount of $200 and a contract term of 12 months.

Returning to FIG. 1, at optional step 102, the plurality of repeating transfer groups are filtered to remove any repeating transfer groups having a quantity of repeating transfer data structures below a minimum threshold. This step can be performed prior to the remaining steps shown in FIG. 1, including step 103 of identifying a plurality of primary repeating transfer data structures and a plurality of backup repeating transfer data structures in each repeating transfer group. Primary repeating transfer data structures and backup repeating transfer data structures are discussed in greater detail with respect to step 103.

In the invoice/receivable financing context, step 102 can include filtering the plurality of MPGs to remove any MPGs having a quantity of recurring receivables contracts below a minimum threshold.

The minimum threshold value used for filtering the MPGs can be set to some default value, such as 10 recurring revenue contracts. Alternatively, the minimum threshold value can be set by an administrator of the invoice/receivables financing system, a funder that provides financing, and/or a seller that provides the invoices/recurring receivables.

The filtering step ensures that each remaining MPG contains a sufficient number of recurring revenue receivables contracts to provide backup or reserve contracts in the event of cancellation or termination of another contract in the MPG, as will be discussed in greater detail below.

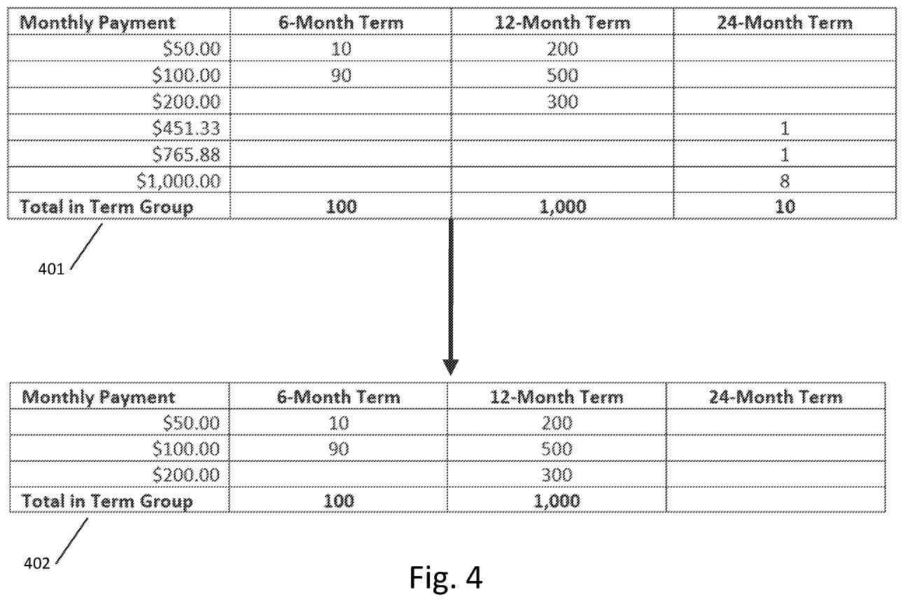

FIG. 4 illustrates an example of the step of filtering the plurality of MPGs to remove any MPGs having a quantity of recurring receivables contracts below a minimum threshold according to an exemplary embodiment.

Table 401 shows a first plurality of MPGs (with each MPG corresponding to a different cell) and a quantity of recurring receivables contracts in each MPG (the value in each cell corresponding to each MPG). Table 402 illustrates a second plurality of MPGs after filtering the first plurality of MPGs to remove any MPGs having a quantity of recurring receivables contracts below a minimum threshold of 10 contracts.

As shown in table 401, each of the MPGs in the 24 month term have less than 10 contracts each. Specifically, there is one contract in the MPG having a monthly payment of $451.33, one contract in the MPG having a monthly payment of $765.88, and eight contracts in the MPG having a monthly payment of $1,000. All of these MPGs are filtered out based on not meeting the minimum threshold requirement for contracts, as shown in table 402.

Returning to FIG. 1, at step 103 a plurality of primary repeating transfer data structures and a plurality of backup repeating transfer data structures are identified in each repeating transfer group based at least in part on a utilization ratio.

In the invoice/receivable financing context, the utilization ratio can be a funding ratio, the primary repeating transfer data structures can be fundable recurring receivables contracts and the backup repeating transfer data structures can be non-fundable recurring receivables contracts. In this case, step 103 can include identifying a plurality of fundable recurring receivables contracts and a plurality of non-fundable recurring receivables contracts in each MPG based at least in part on a funding ratio.

The funding ratio is the ratio of the quantity of contracts that can be funded in each MPG relative to the quantity of contracts that are held in reserve for backup purposes, in the event that one of the funded contracts is canceled or otherwise terminated. The funding ratio can be hard-coded as a specific value for all funders or can be set on a funder-by-funder basis. Alternatively, each funder can specify a funding ratio that they require in order to provide funding for recurring revenue receivables contracts.

In an exemplary embodiment, the funding ratio can be hard-coded as 30%, meaning three out of every ten contracts in an MPG are fundable/funded and seven out of every ten contracts in an MPG are held in reserve as “non-fundable.” Non-fundable contracts are not fundable at the current time, but may be fundable at a later point in time (e.g., when/if a fundable contract is terminated).

Additionally, any fundable result that is not a whole number is rounded down. For instance, if the funding ratio is 30% and there are 55 recurring receivable contracts in an MPG (cell), the breakdown would be 0.3*55=16.5 fundable recurring receivable contracts and 0.7*55=38.5 non-fundable/backup recurring receivable contracts. Since fractions of recurring receivable contracts cannot be funded, the fundable recurring receivable contracts would be rounded down to 16, leaving 39 non-fundable/backup recurring receivable contracts.

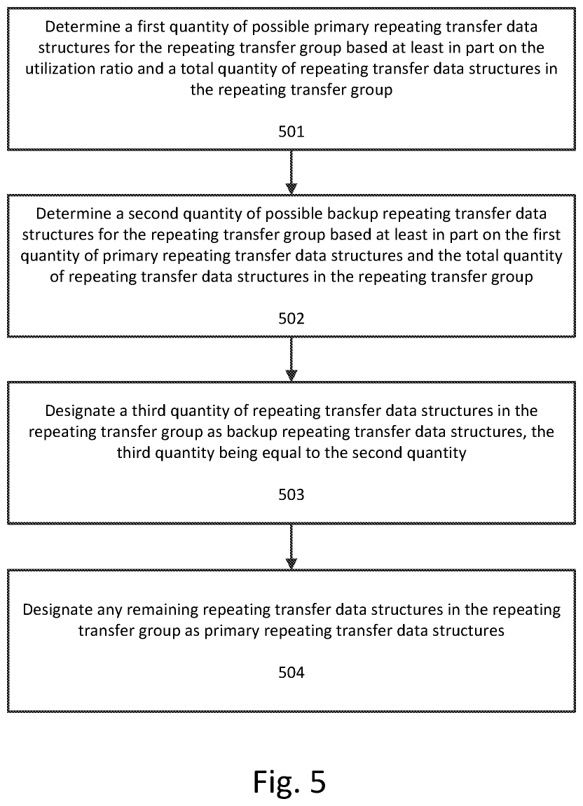

FIG. 5 illustrates a flowchart for identifying a plurality of primary repeating transfer data structures and a plurality of backup repeating transfer data structures in each repeating transfer group based at least in part on a utilization ratio according to an exemplary embodiment. The steps shown in FIG. 5 are performed for each repeating transfer group in order to identify primary repeating transfer data structures and backup repeating transfer data structures.

In the invoice/receivable financing context, the steps shown in FIG. 5 correspond to a process for identifying a plurality of fundable recurring receivables contracts and a plurality of non-fundable recurring receivables contracts in each MPG based at least in part on a funding ratio according to an exemplary embodiment. In this case, the steps shown in FIG. 5 would be performed for each MPG in order to identify fundable recurring receivables contracts and non-fundable recurring receivables contracts.

At step 501 a first quantity of possible primary repeating transfer data structures for the repeating transfer group is determined based at least in part on the utilization ratio and a total quantity of repeating transfer data structures in the repeating transfer group.

In the invoice/receivable financing context, a first quantity of possible fundable recurring receivables contracts for the MPG is determined based at least in part on the funding ratio and a total quantity of recurring receivables contracts in the MPG. Specifically, the first quantity of possible fundable recurring receivables contracts is determined as the product of the total quantity of recurring receivables contracts in the MPG and the funding ratio. As discussed previously, if the product of the total quantity of recurring receivables contracts in the MPG and the funding ratio is not a whole number, then the product is rounded down to the nearest whole number to determine the first quantity of possible fundable recurring receivables contracts for the MPG.

At step 502 a second quantity of possible backup repeating transfer data structures for the repeating transfer group is determined based at least in part on the first quantity of primary repeating transfer data structures and the total quantity of repeating transfer data structures in the repeating transfer group.

In the invoice/receivable financing context, a second quantity of possible non-fundable recurring receivables contracts for the MPG is determined based at least in part on the first quantity of fundable recurring receivables contracts and the total quantity of recurring receivables contracts in the MPG. Specifically, the first quantity of possible fundable recurring receivables contracts is subtracted from the total quantity of contracts in the MPG to determine the second quantity of possible non-fundable recurring receivables contracts for the MPG.

At step 503 a third quantity of repeating transfer data structures in the repeating transfer group are designated as backup repeating transfer data structures, the third quantity being equal to the second quantity.

In the invoice/receivable financing context, a third quantity of recurring receivables contracts in the MPG are designated as non-fundable recurring receivables contracts, the third quantity being equal to the second quantity. This step involves designating non-fundable recurring receivables contracts from the set of contracts in the MPG and can be performed in a variety of ways. The designation of non-fundable recurring receivables contracts within the MPG can be performed randomly. So, if there are 60 recurring revenue contracts in an MPG and 10 recurring revenue contracts must be designated as non-fundable, then 10 contracts out the 60 contracts can be randomly or pseudorandomly selected and assigned non-fundable status. Alternatively, contracts can be designated as non-fundable in the order or reverse order of storage or organization of the MPG. For example, if 10 contracts must be designated non-fundable, then the first 10 contracts in the MPG or the last 10 contracts in the MPG can be designated non-fundable.

At step 504 any remaining repeating transfer data structures in the repeating transfer group are designated as primary repeating transfer data structures.

In the invoice/receivable financing context, any remaining recurring receivables contracts in the MPG are designated as fundable recurring receivables contracts. The quantity of remaining recurring receivables contracts will be equal to the first quantity of possible fundable recurring receivables contracts.

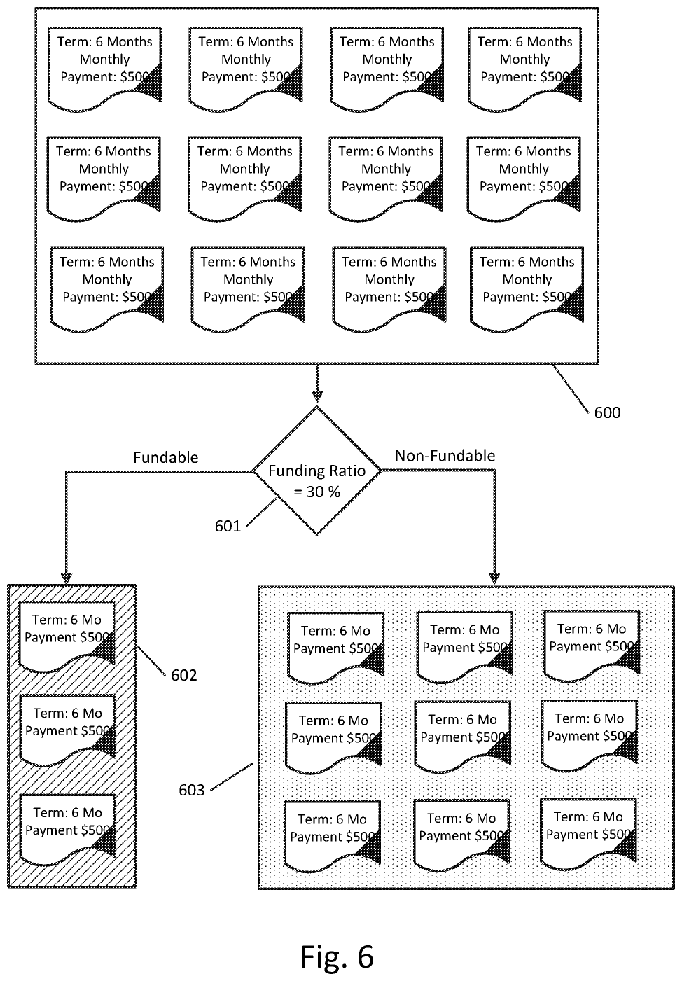

FIG. 6 illustrates an example of identifying a plurality of fundable recurring receivables contracts and a plurality of non-fundable recurring receivables contracts in an MPG based at least in part on a funding ratio according to an exemplary embodiment.

Box 600 illustrates an MPG corresponding to a 6 month term and a monthly payment amount of $500. As indicated at 601, the funding ratio is 30%, and when applied to the contracts in the MPG shown in box 600, results in fundable contracts 602 and non-fundable contracts 603. To determine the first quantity of possible fundable contracts for the MPG, the product of the funding ratio of 30% and the total quantity of contracts in MPG 600 is computed. This is equal to 0.3×12=3.6. This result is rounded down to 3, resulting in 3 fundable contracts, as shown in box 602. The remaining 9 contracts are non-fundable, as shown in box 603.

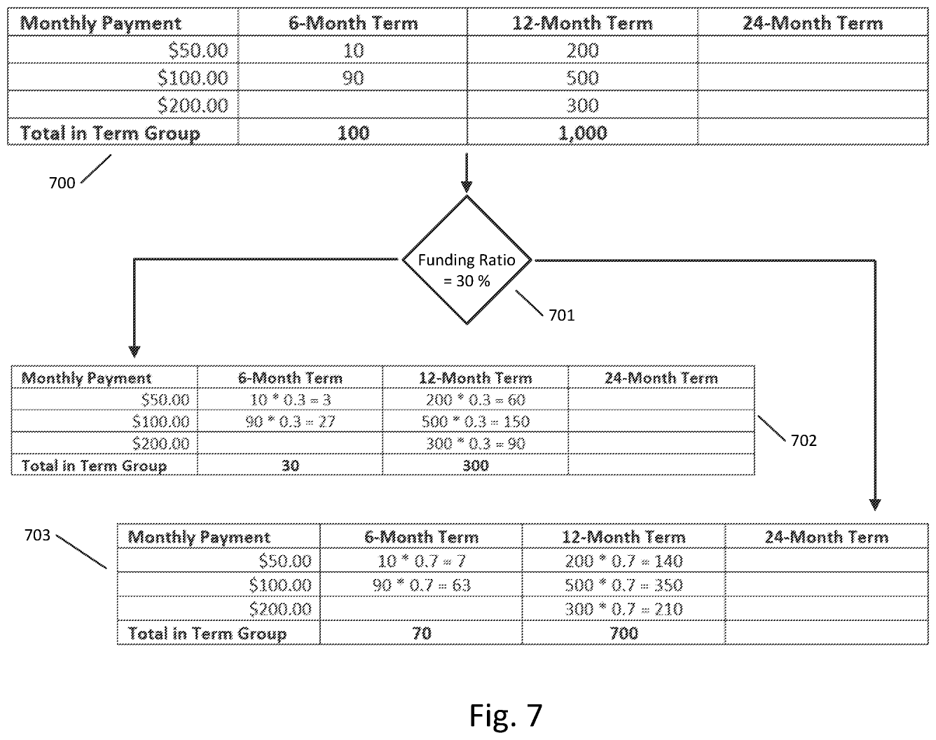

FIG. 7 illustrates an example of identifying a plurality of fundable recurring receivables contracts and a plurality of non-fundable recurring receivables contracts in multiple MPGs based at least in part on a funding ratio according to an exemplary embodiment.

Two term groups are shown in table 700, with each term group having multiple MPGs. There are five MPGs that have recurring receivables contracts, including a 6 month/$50 per month group, a 6 month/$100 per month group, a 12 month/$50 per month group, a 12 month/$100 per month group, and a 12 month/$200 per month group.

A funding ratio 701 of 30% is applied to the MPGs shown in table 700, resulting in the fundable recurring receivables contracts in each MPG shown in table 702 and the non-fundable recurring receivables contracts in each MPG shown in table 703. For example, the MPG corresponding to a 6 month term and a monthly payment of $100 per month has a total of 90 contracts (table 700), 27 of which are designated as fundable (table 702) and 63 of which are designated as non-fundable (table 703).

Returning to FIG. 1, at step 104, the plurality of primary repeating transfer data structures in the plurality of repeating transfer groups are stored in a plurality of primary groups in a memory of at least one of the one or more computing devices and the plurality of backup repeating transfer data structures in the plurality of repeating transfer groups are stored in a plurality of backup queues in the memory. Each backup queue corresponding to a repeating transfer group is linked in the memory to a primary group corresponding to the same repeating transfer group. For example, each backup queue can be stored in a data structure having a pointer to a corresponding primary group.

In the invoice/receivables financing context, step 104 can include storing the plurality of fundable recurring receivables contracts in the plurality of MPGs in a plurality of fundable groups in a memory of at least one of the one or more computing devices and storing the plurality of non-fundable recurring receivables in the plurality of MPGs in a plurality of non-fundable groups, such as non-fundable queues, in the memory. As explained in greater detail below, each non-fundable group (e.g., each non-fundable queue) corresponding to an MPG is linked in the memory to a fundable group corresponding to the same MPG.

Fundable groups and the contracts within the fundable groups can be stored in memory in a variety of data structures. For example, fundable groups can be stored in one or more of a class object, a struct object, an array, a linked list, or a multidimensional array. Fundable groups can also be stored in one or more tables and/or a relational database, such as a SQL database.

Similarly, non-fundable groups and the contracts within the non-fundable groups can be stored in memory in a variety of data structures. The non-fundable groups can be comprised of one or more of a class object, a struct object, an array, a linked list, a queue, or a multidimensional array. The non-fundable groups can also be stored in one or more tables and/or a relational database, such as a SQL database.

In an exemplary embodiment, the non-fundable groups are non-fundable queues, with each non-fundable queue storing a plurality of non-fundable contracts. The contracts within a non-fundable queue can be arranged in some predetermined order or can be unsorted and/or randomly distributed. When a replacement contract is required from a non-fundable queue (as will be discussed further below), the replacement contract can be selected as the first contract (e.g., in an ordered queue) or can be randomly selected from the plurality of non-fundable contracts (e.g., in an unordered queue).

While this disclosure references non-fundable groups and non-fundable queues, it is understood that a non-fundable queue is one possible organizational structure of a non-fundable group, and other structures are possible, as discussed above.

The fundable groups and non-fundable queues can also be stored in the same data structure and differentiated using a variable or flag or bit structure. For example all contracts within an MPG can be stored in a specialized table or other data structure that includes contract information, contract terms, payment amounts, contract parameters, and flags indicating whether a particular contract is fundable or non-fundable. For example, a fundable flag can be associated with each contract in an MPG that, if set to true, indicates that the contract is fundable and, if false, indicates that the contract is non-fundable.

Each non-fundable group (e.g., each non-fundable queue) corresponding to an MPG is linked in the memory to a fundable group corresponding to the same MPG. This linkage can take a variety of forms, depending on the particular data structures used to store the fundable group and non-fundable groups. For example, if the fundable and non-fundable groups are stored in different tables, such as in a relational database, then each non-fundable group table can store a foreign key that accesses a corresponding fundable group table. If other data structures are used, such as arrays, linked lists, and/or class objects, then a pointer or other linkage mechanism can be used to have each non-fundable group point to a corresponding fundable group. In another example, if arrays or multidimensional arrays are used, then each pair of corresponding fundable and non-fundable groups can use the same index values. In another example, the linkage can be stored in memory by having each pair of corresponding fundable and non-fundable groups be stored in the same data structure, such as in a single specialized table or data structure that is accessed via a single handle, variable name, or table name.

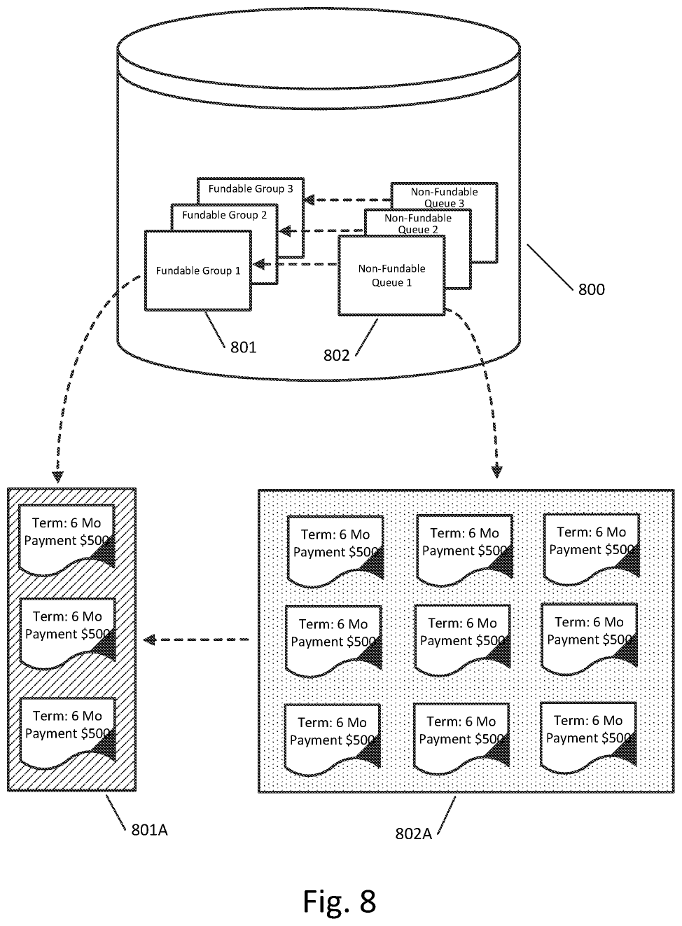

FIG. 8 illustrates an example of a fundable group and the corresponding non-fundable group in memory according to an exemplary embodiment. In the example of FIG. 8, the non-fundable groups are non-fundable queues. As shown in FIG. 8, memory 800 stores multiple fundable groups 801 and multiple non-fundable queues 802, with the non-fundable queues 802 being linked in memory to the fundable groups 801.

Box 801A illustrates a fundable group including three fundable contracts corresponding to a particular MPG (6 month term and $500 monthly payment) and box 802A illustrates a non-fundable queue including nine non-fundable contracts corresponding to the same MPG (6 month term and $500 monthly payment). The non-fundable queue 802A is linked in memory to the fundable group 801A and the non-fundable contracts in the non-fundable queue 802A serve as backup/reserve contracts for the contracts in the fundable group 801A in the event of cancellation or termination of the contracts in fundable group 801A.

Returning to FIG. 1, at step 105 failure of a primary repeating transfer data structure in a first primary group corresponding to a first repeating transfer group in the plurality of repeating transfer groups is detected.

In the invoice/receivable funding context, this step can include detecting cancellation of a fundable recurring receivables contract in a first fundable group corresponding to a first MPG in the plurality of MPGs. The cancellation is typically detected after the fundable recurring receivables contract is funded but can also be detected at some point prior to actual funding.

Cancellation can be caused by a number of different conditions, including termination of the contract by the seller, a default or late payment by the buyer, renegotiation or postponement of the contract, a material change in contract terms, time periods, and/or payment amounts, or any other conditions which affect the terms, expected cash flow, or future collections from the contract.

Detection of cancellation of a fundable recurring receivables contract can be accomplished in a number of ways. The invoice/receivables financing platform of the present system can connect to buyer systems, seller systems, and funder systems. When a contract termination, default, postponement, change in terms, or other action occurs, then the buyer system or seller system can notify the invoice financing platform, which then detects that the relevant contract has been canceled. Alternatively or additionally, the invoice financing system can detect an event, such as a buyer missing a payment on a contract, which can then result in cancellation of the corresponding contract.

At step 106, in response to detecting failure of the primary repeating transfer data structure, the failed primary repeating transfer data structure is removed from the first primary group and a backup repeating transfer data structure from a first backup queue corresponding to the first repeating transfer group and linked in the memory to the first primary group is substituted into the first primary group.

In the receivable/invoice financing context, step 106 can include, in response to detecting cancellation of the fundable recurring receivables contract, removing the cancelled fundable recurring receivables contract from the first fundable group and substituting a non-fundable recurring receivables contract from a first non-fundable queue/group corresponding to the first MPG and linked in the memory to the first fundable group into the first fundable group.

Removal of the cancelled fundable recurring receivables contract from the first fundable group can be accomplished in a number of ways. For example, the records, table entries, or other data structures corresponding to the cancelled fundable recurring receivables contract can be deleted from the data structure corresponding to the fundable group. Alternatively, a flag or other variable can be set indicating that the cancelled fundable recurring receivables contract is no longer part of the first fundable group.

Substitution of a non-fundable recurring receivables contract from the first non-fundable queue/group corresponding to the first MPG that is linked in the memory to the first fundable group can include the step of changing the designation of the substituted non-fundable recurring receivables contract from non-fundable to fundable. The substitution step can also include transferring the records, table entries, or other data structures corresponding to the non-fundable recurring receivables contracts from the non-fundable group/queue to the data structure corresponding to the fundable group.

The non-fundable recurring receivables contract that is selected from the first non-fundable queue/group can be selected in a variety of ways. For example, the substituted non-fundable recurring receivables contract can be selected randomly or pseudo-randomly, or the substituted non-fundable recurring receivables contract can be selected in a predetermined order (e.g., starting with the first non-fundable recurring receivables contract stored in the memory/fundable group and proceeding in order of storage within the memory/fundable group).

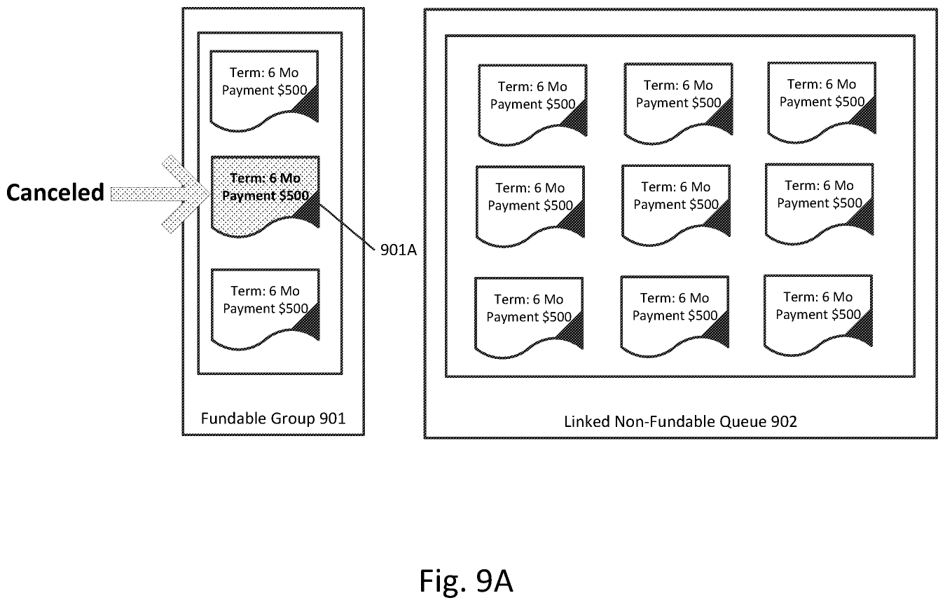

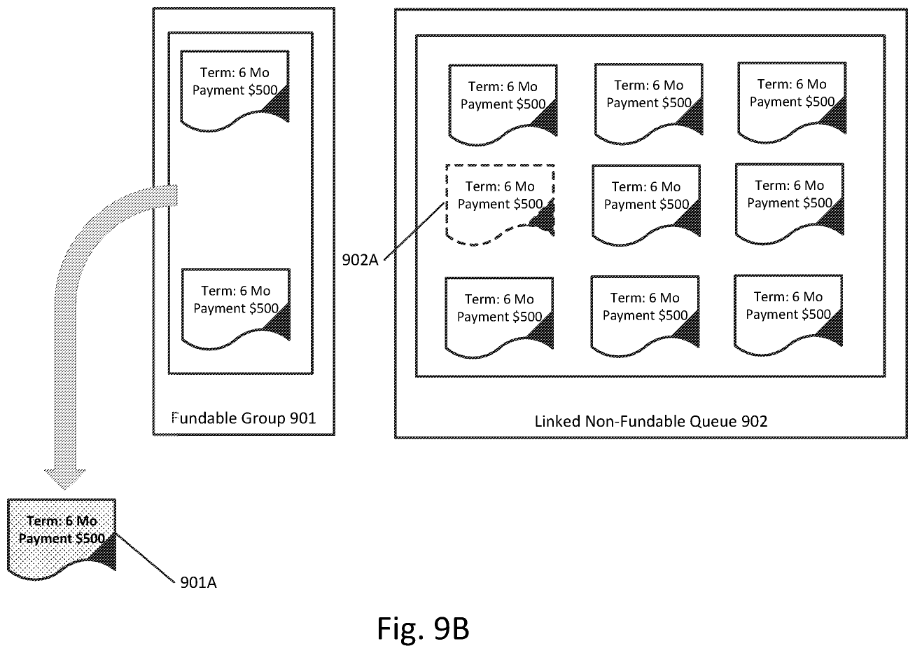

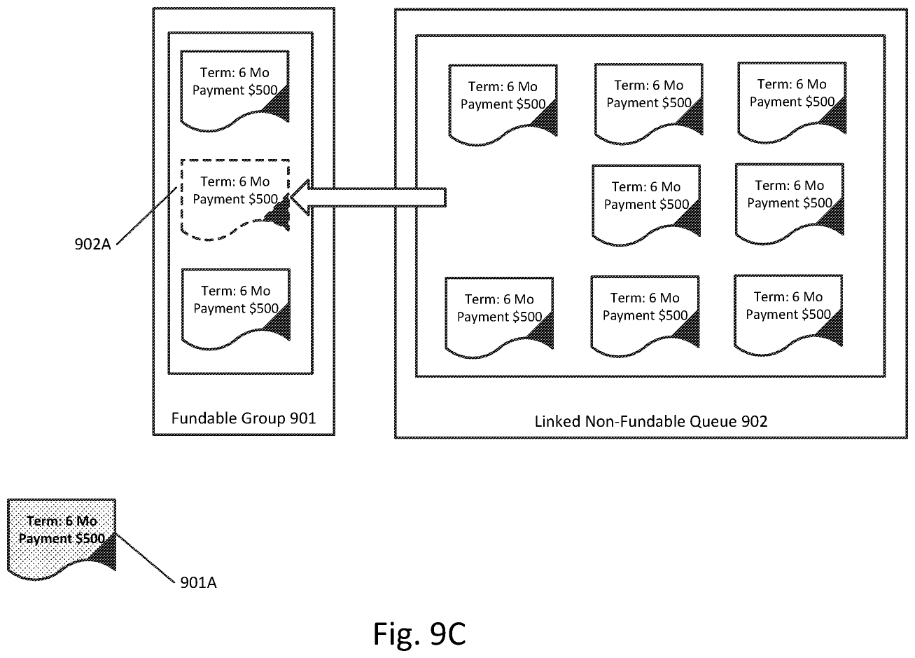

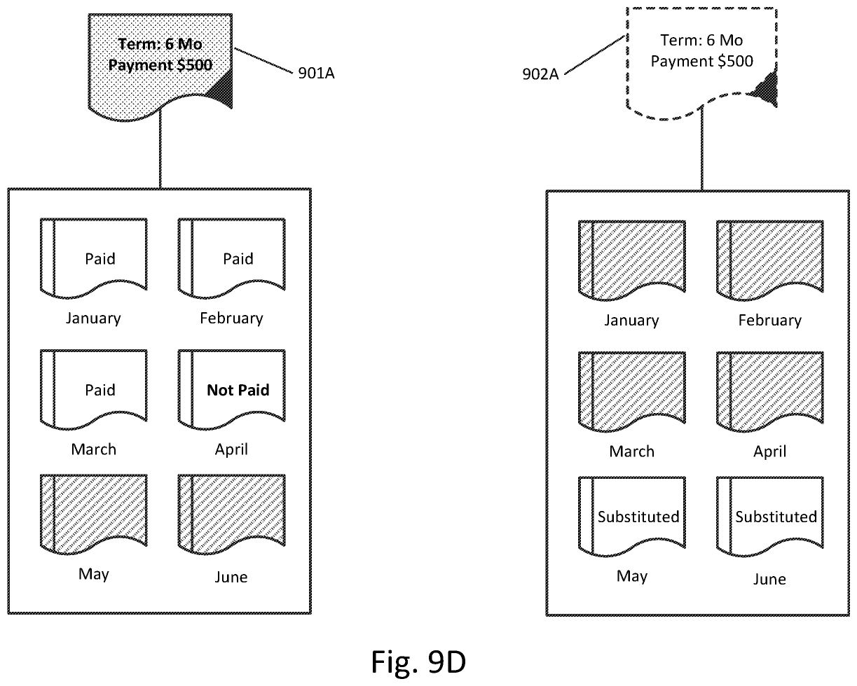

FIGS. 9A-9D illustrate an example of the contract cancellation and contract substitution steps (105-106 in FIG. 1) according to an exemplary embodiment. Fundable group 901, having three fundable contracts, is linked to non-fundable queue 902, having nine non-fundable contracts.

As shown in FIG. 9A, contract 901A is canceled. As indicated in FIG. 9B, canceled recurring receivables contract 901A is removed from the fundable group 901. Subsequently or concurrently, non-fundable recurring receivables contract 902A in the non-fundable queue 902 is designated as the replacement contract. Referring to FIG. 9C, the non-fundable recurring receivables contract 902A is designated as a fundable recurring receivables contract and moved from the non-fundable queue 902 to the fundable group 901.

FIG. 9D illustrates an example of the contract cancellation and replacement shown in FIG. 9C in more granular detail. As shown in FIG. 9D, recurring receivables contract 901A (which is initially in the fundable group) is a 6 month contract and includes anticipated invoices/receivables for January, February, March, April, May, and June. Similarly, recurring receivables contract 902A (which is initially in the non-fundable queue as a backup contract) is also a 6 month contract and also includes anticipated invoices/receivables for January, February, March, April, May, and June.

In the example shown in FIG. 9D, the invoices for recurring receivables contract 901A for January-March are all paid. However, the invoice for April for recurring receivables contract 901A is not paid. This can result in cancellation of the overall contract, meaning the future invoices for May and June for recurring receivables contract 901A are voided.

Due to the cancellation of the contract and insertion of replacement recurring receivables contract 902A into the fundable queue, the voided May and June invoices for canceled recurring receivables contract 901A are substituted with the May and June invoices for replacement recurring receivables contract 902A. As shown in the figure, the January-April invoices for replacement recurring receivables contract 902A are not part of the funds routed to funder, since at this point the replacement recurring receivables contract 902A is in the non-fundable queue and not the fundable group.

However, this leaves the question of which party should incur costs for the non-payment/default of the April invoice in recurring receivables contract 901A. By default, since the funder assumes responsibility for collection on the recurring receivables contracts at the time of funding and the seller serves mainly as a reimbursement/forwarding agent for payments from a buyer, the funder can absorb the losses causes by the non-payment of the April invoice in recurring receivables contract 901A. In other words, the funder assumes the risk of costs incurred due to cancelation of contracts. In this scenario, a true sale occurs of the outstanding invoices/receivables from the seller to the funder.

Alternatively, in certain circumstances, the seller can incur the costs for the non-payment/default of the April invoice in recurring receivables contract 901A. The seller can be obligated to incur the costs when, for example, the seller stops providing services, the seller's services/goods are defective, and/or the seller performs some other action that causes the buyer to legitimately not pay an outstanding invoice.

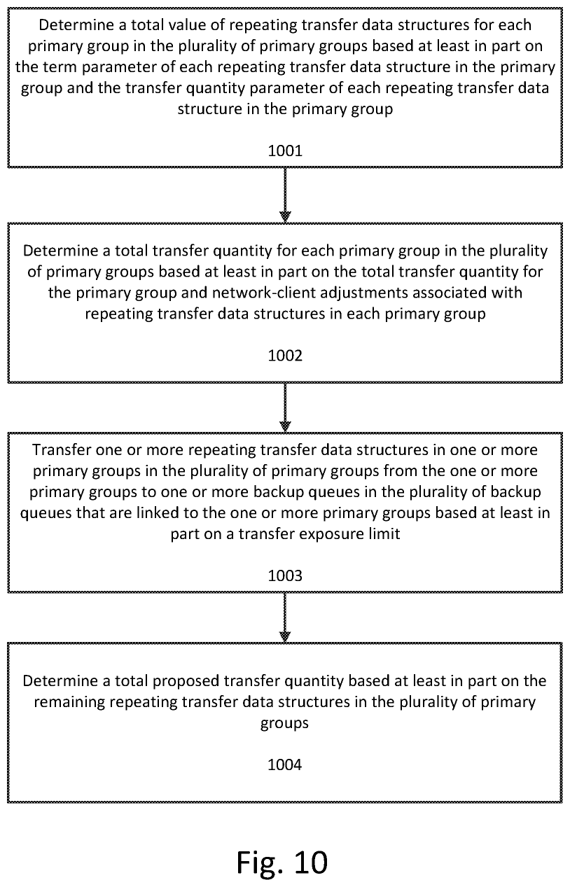

FIG. 10 illustrates a flowchart for determining a total proposed transfer quantity based at least in part on the remaining repeating transfer data structures in the plurality of primary groups according to an exemplary embodiment. In the invoice/receivables financing context, this step can include determining a total proposed funding based at least in part on the plurality of fundable groups.

At step 1001 a total value of repeating transfer data structures for each primary group in the plurality of primary groups is determined based at least in part on the term parameter of each repeating transfer data structure in the primary group and the transfer quantity parameter of each repeating transfer data structure in the primary group.

In the invoice/receivables financing context, a total value of recurring receivables contracts for each fundable group in the plurality of fundable groups is determined based at least in part on the contract term of each recurring receivables contract in the fundable group and the monthly payment amount of each recurring receivables contract in the fundable group. The total value of recurring receivables contracts for each fundable group can be determined as the product of the quantity of contracts in the fundable group, the monthly payment for the MPG corresponding to the fundable group, and the contract term for the MPG corresponding to the fundable group.

At step 1002 a total transfer quantity for each primary group in the plurality of primary groups is determined based at least in part on the total transfer quantity for the primary group and network-client adjustments associated with repeating transfer data structures in each primary group.

In the invoice/receivables financing context, a total funding amount for each fundable group in the plurality of fundable groups is determined based at least in part on the total value for the fundable group and discount rates associated with recurring receivables contracts in each fundable group. The total funding amount for each fundable group is less than the total value for the fundable group because the total value of the funding group is adjusted by a discount rate. In this context, the discount rates are the network-client adjustments associated with repeating transfer data structures in each primary group.

The discount rate is the total proportion of the invoice/recurring revenue receivable contract amount that the recurring revenue receivable contract Seller must sacrifice in order to receive early payment of the balance of the invoice's value. The discount rate is the return on investment/principal for the funder.

The total funding amount for each fundable group is determined as the product of the total value for the fundable group and (1−the discount rate).

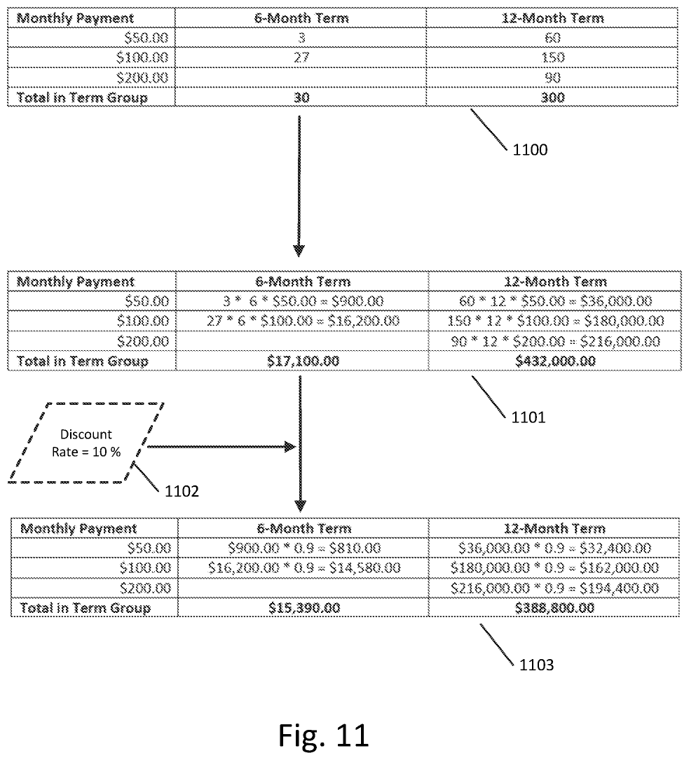

FIG. 11 illustrates an example of the steps of determining a total value of recurring receivables contracts for each fundable group in the plurality of fundable groups and determining a total funding amount for each fundable group in the plurality of fundable groups according to an exemplary embodiment.

Table 1100 illustrates the quantity of fundable contracts in each of a plurality of fundable groups corresponding to a plurality of MPGs. For example, the fundable group corresponding to the MPG having a 6 month term and $50 monthly payment has three fundable contracts and the fundable group corresponding to the MPG having a 6 month term and $100 monthly payment has twenty-seven fundable contracts.

Table 1101 illustrates the total value of recurring receivables contracts in each of a plurality of fundable groups corresponding to a plurality of MPGs. For example, the fundable group corresponding to the MPG having a 6 month term and $50 monthly payment has three fundable contracts, so the total value of recurring receivables contracts in that fundable group is the product 3*6*$50=$900.

As shown in FIG. 11, discount rate 1102 of 10% is applied to the total values for each of the plurality of funding groups in table 1101, resulting in the total funding amounts for each of the plurality of funding groups shown in table 1103. For example the fundable group corresponding to the MPG having a 6 month term, $50 monthly payment, and three fundable contracts has a total funding amount of $810 (the total value of $900×0.9), since the discount rate is 0.1.

Returning to FIG. 10, at step 1003 one or more repeating transfer data structures in one or more primary groups in the plurality of primary groups are transferred from the one or more primary groups to one or more backup queues in the plurality of backup queues that are linked to the one or more primary groups based at least in part on a transfer exposure limit.

In the invoice/receivables financing context, one or more recurring revenue contracts in one or more fundable groups in the plurality of fundable groups are transferred from the one or more fundable groups to one or more non-fundable groups/queues in the plurality of non-fundable groups/queues that are linked to the one or more fundable groups based at least in part on a funder exposure limit. In this context, the funder exposure limit is the transfer exposure limit.

Funders can set an exposure limit for the total amount of funding that they can finance at any one time. Alternatively, a funder exposure limit can be set by the platform administrator. The funder exposure limit constrains the amount of new funding that can be taken on. For instance, assume that a funder company has a funder exposure limit of $3,000,000.00 and has $2,500,000.00 in funding outstanding. In this case, only $3,000,000.00−$2,500,000.00=$500,000.00 of new funding can be provided until some of the existing funding is repaid. Note that the funder exposure limit pertains to the funder in question and not any particular seller (i.e., it takes into account the funder's exposure across all sellers on the financing platform and not just a single seller).

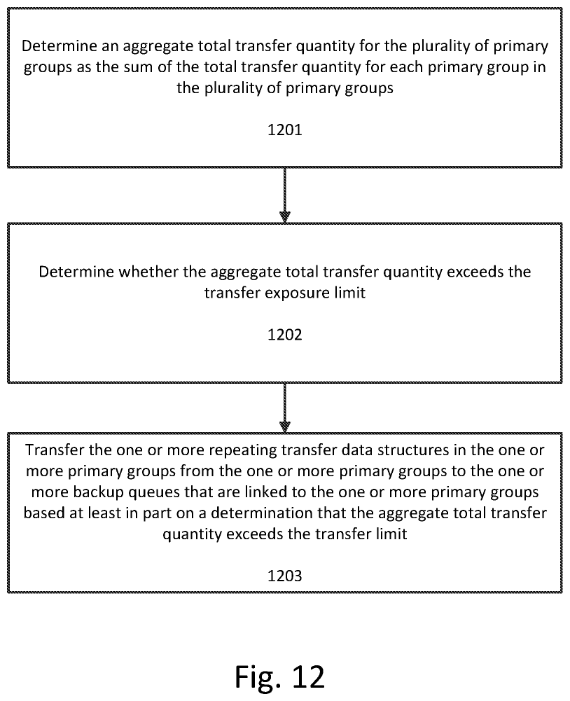

FIG. 12 illustrates a flowchart for transferring one or more repeating transfer data structures in one or more primary groups in the plurality of primary groups from the one or more primary groups to one or more backup queues in the plurality of backup queues that are linked to the one or more primary groups based at least in part on a transfer exposure limit according to an exemplary embodiment. In the invoice/receivables financing context, the steps in this flowchart correspond to transferring one or more recurring revenue contracts in one or more fundable groups in the plurality of fundable groups from the one or more fundable groups to one or more non-fundable queues in the plurality of non-fundable queues that are linked to the one or more fundable groups based at least in part on a funder exposure limit.

At step 1201 an aggregate total transfer quantity for the plurality of primary groups is determined as the sum of the total transfer quantity for each primary group in the plurality of primary groups.

In the invoice/receivables financing context, an aggregate total funding amount for the plurality of fundable groups is determined as the sum of the total funding amount for each fundable group in the plurality of fundable groups. This aggregate total is computed by combining the total funding amounts for the plurality of fundable groups.

At step 1202 it is determined whether the aggregate total transfer quantity exceeds the transfer exposure limit.

In the invoice/receivables financing context, it is determined whether the aggregate total funding amount exceeds the funder exposure limit.

At step 1203 the one or more repeating transfer data structures in the one or more primary groups from the one or more primary groups are transferred to the one or more backup queues that are linked to the one or more primary groups based at least in part on a determination that the aggregate total transfer quantity exceeds the transfer limit.

In the invoice/receivables financing context, the one or more recurring revenue contracts in the one or more fundable groups are transferred from the one or more fundable groups to the one or more non-fundable groups/queues that are linked to the one or more fundable groups based at least in part on a determination that the aggregate total funding amount exceeds the funder exposure limit.

Step 1203 can include iteratively removing the one or more repeating transfer data structures in the one or more primary groups from the one or more primary groups until an updated aggregate total transfer quantity of the remaining repeating transfer data structures in the plurality of primary groups is less than or equal to the transfer exposure limit. The step of iteratively removing the one or more repeating transfer data structures in the one or more primary groups from the one or more primary groups until an updated aggregate total transfer quantity of the remaining repeating transfer data structures in the plurality of primary groups is less than or equal to the transfer exposure limit can include removing repeating transfer data structures having higher total transfer quantities prior to removing repeating transfer data structures having lower total transfer quantities, wherein the total transfer quantity for each individual repeating transfer data structures is determined as the product of the term parameter and the transfer quantity parameter.

In the invoice/receivables financing context, step 1203 can include iteratively removing the one or more recurring revenue contracts in the one or more fundable groups from the one or more fundable groups until an updated aggregate total funding amount of the remaining recurring revenue contracts in the plurality of fundable groups is less than or equal to the funder exposure limit. The step of iteratively removing the one or more recurring revenue contracts in the one or more fundable groups from the one or more fundable groups until an updated aggregate total funding amount of the remaining recurring revenue contracts in the plurality of fundable groups is less than or equal to the funder exposure limit can include removing recurring revenue contracts having higher funding amounts prior to removing recurring revenue contracts having lower funding amounts. The funding amount for each individual recurring revenue contract can be determined as the product of the contract term and the monthly payment amount.

Step 1203 can include transferring the removed one or more repeating transfer data structures to the one or more backup queues that are linked to the one or more primary groups. In the invoice/receivables financing context, step 1203 can also include transferring the removed one or more recurring revenue contracts to the one or more non-fundable groups/queues that are linked to the one or more fundable groups.

Returning to FIG. 10, at step 1004 a total proposed transfer quantity is determined based at least in part on the remaining repeating transfer data structures in the plurality of primary groups. In the invoice/receivables financing context, this step can include determining a total proposed funding based at least in part on the remaining recurring revenue contracts in the plurality of fundable groups.

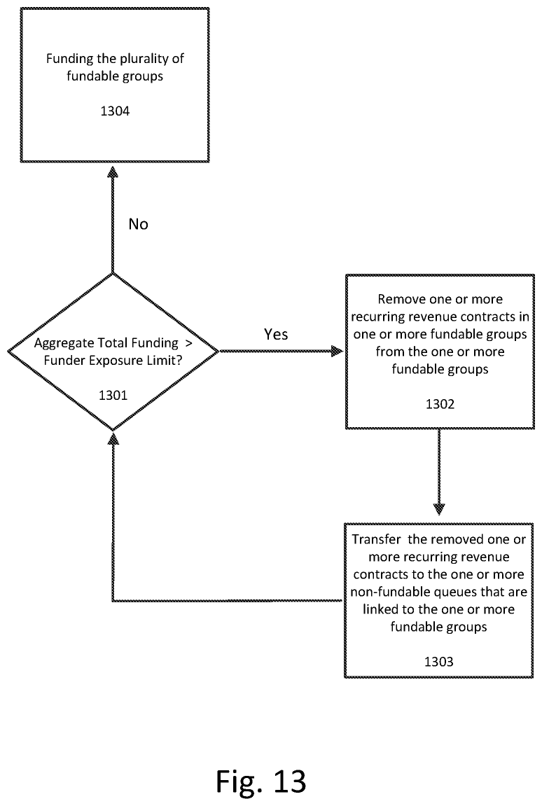

FIG. 13 illustrates a flowchart in the invoice/receivables financing context for transferring the one or more recurring revenue contracts in the one or more fundable groups from the one or more fundable groups to the one or more non-fundable queues that are linked to the one or more fundable groups based at least in part on a determination that the aggregate total funding amount exceeds the funder exposure limit according to an exemplary embodiment.

At step 1301 a determination is made regarding whether the aggregate total funding is greater than the funder exposure limit. If the aggregate total funding is not greater than the funder exposure limit, then at step 1304 the plurality of fundable groups are funded. If the aggregate total funding is greater than the funder exposure limit, then at step 1302 one or more recurring revenue contracts in one or more fundable groups are removed from the one or more fundable groups. After step 1302, the process proceeds to step 1303 and the removed one or more recurring revenue contracts are transferred to the one or more non-fundable groups/queues that are linked to the one or more fundable groups. After step 1303 the process returns to step 1301 and a determination is made regarding whether the updated aggregate total funding (after removal of the contracts) is greater than the funder exposure limit. The steps repeat until the aggregate total funding is less than or equal to the funder exposure limits.

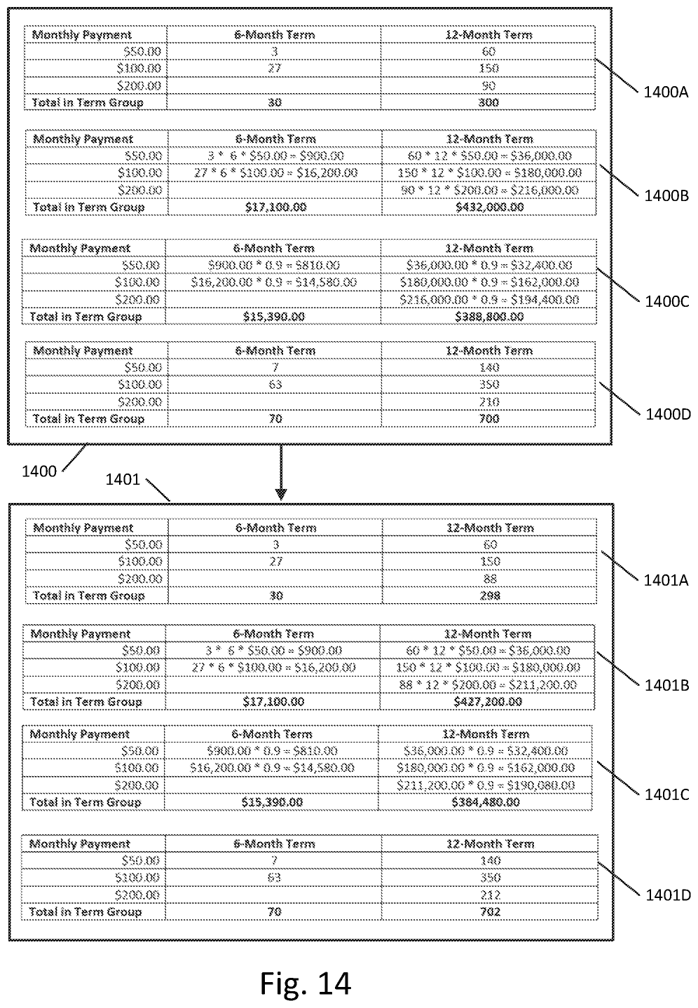

FIG. 14 illustrates an example of transferring the one or more recurring revenue contracts in the one or more fundable groups from the one or more fundable groups to the one or more non-fundable queues that are linked to the one or more fundable groups based at least in part on a determination that the aggregate total funding amount exceeds the funder exposure limit according to an exemplary embodiment.

Box 1400 corresponds to the MPGs prior to the transfer of contracts from fundable groups and includes table 1400A indicating the quantities of contracts in each fundable group, table 1400B indicating the total value of contracts for each fundable group, table 1400C indicating the total funding amount for each fundable group, and table 1400D indicating the quantities of contracts in each non-fundable group/queue.

For the purpose of this example, it is assumed that the funder exposure limit is $400,000. As shown in table 1400C, the total funding amount for the 6 month term group is $15,390 and the total funding amount for the 12 month term group is $388,800. The aggregate total funding amount for the plurality of fundable groups is therefore $15,390+$388,800=$404,190. As the funder exposure limit is $400,000, it is necessary to remove contracts having an aggregate total funding amount of at least $4,190 from the fundable groups.

Box 1401 corresponds to the MPGs subsequent to the transfer of contracts from fundable groups and includes table 1401A indicating the quantities of contracts in each fundable group, table 1401B indicating the total value of contracts for each fundable group, table 1401C indicating the total funding amount for each fundable group, and table 1401D indicating the quantities of contracts in each non-fundable group/queue.

As can be seen by comparing tables 1400A and 1400D with tables 1401A and 1401D, two contracts have been moved from the fundable group corresponding to the MPG having a 12 month term and $200 monthly payment amount to the non-fundable group/queue linked to that fundable group and corresponding to the same MPG. Specifically, table 1400A indicates 300 contracts in the relevant MPG and table 1401A indicates 298 contracts in that MPG. As shown in tables 1400D and 1401D, those two contracts are moved to the non-fundable group/queue corresponding to the same MPG (which increases in size from 700 contracts to 702 contracts).

As shown in table 1401C, the total funding amount for the 6 month term group is $15,390 and the total funding amount for the 12 month term group is $384,480. The aggregate total funding amount for the plurality of fundable groups is therefore $15,390+$384,480=$399,870. As this is less than the funder exposure limit is $400,000, the fundable groups can then be funded.

Funder Parameters

The receivables financing platform utilizes a variety of parameters when forming the MPGs, fundable groups, and funding the fundable group. Funders can optionally input values for these parameters in a settings input interface. Funders can choose

Annual discount rate. In a two-decimal-point numeric data-entry field, the funder enters a number from 0.00% to 24.00%. 8.00% is the default.

Maximum receivables term. In a dropdown list, the funder selects a number from 1 to 36 months as the maximum term for recurring-revenue receivables. The number 12 months is the default.

Maximum total exposure (i.e., funding limit). Funder selects a currency from a dropdown list (either USD or GBP, with USD the default) and, in a 10-number, two-decimal-point monetary data-entry field, enters a maximum exposure value. There is no default; the number-field reads 0,000,000,000.00 but the number is grayed out, meaning that there is no exposure limit unless a choice is explicitly made.

Offer good for. The funder can input how long a Seller has to select an offer before the offer expires. This can be input into the interface or selected from a drop-down list, such as 30 minutes, 1 hours, 90 minutes, 2 hours, 3 hours, 4 hours, 6 hours, 8 hours, 10 hours, and/or 12 hours.

Recurring Receivables Upload

The receivables financing platform ingests recurring receivables contracts and can perform the following steps during ingestion:
Month-to-month RRRs with monthly payments, treated as X-month receivables, where X is the maximum term that the Funder has selected at that time
All fixed-term receivables with monthly payments, treated as either the fixed term or the maximum term X that the Funder has selected, whichever is lower.
   Example: fixed term is 12 months, X=15 months, treated as 12-month receivable
   Example: fixed term is 24 months, X=15 months, treated as 15-month receivable
   Example: fixed term is 12 months, X=12 months, treated as 12-month receivable
   Example: fixed term is 12 months, X=6 months, treated as 6-month receivable
Both business-to-business (B2B) and business-to-customer (B2C) plans. Both B2B and B2C plans can be ingested.

Buyer Scoring

The recurring receivables financing platform can perform a variety of different scores to buyers, such as the CIS (company integrity score), KYB score (Know Your Business), AML score (Anti-Money Laundering) or other scores described in the Related Applications. In an exemplary embodiment, the recurring receivables financing platform determines KYB scores for buyers. Contracts from buyers with unacceptable (i.e., below a minimum threshold) KYB scores or other scores can be rejected. Contracts from buyers with no KYB can optionally be allowed.

The financing platform can also determine a “Smart Score” (also referred to as a SuRF Score), as described in the Related Applications. In an exemplary embodiment:
If buyer SuRF Score is <75, the contracts from the buyer are rejected;
If buyer SuRF Score is >=75, the contracts are accepted and the SuRF Score is displayed on relevant tables;
If there are multiple different or no buyer results for a Dun & Bradstreet (D&B) Delinquency Score (DBDS, the contracts are accepted and “N/A” is displayed in the SuRF Score column of the relevant tables;

Receivables having buyers with multiple different results are considered eligible and are placed in the table along with those with acceptable KYB and SuRF Scores.

Receivable Approval

The financing platform can remove certain contracts that are missing information or that do not comply with certain conditions. In an exemplary embodiment, contracts that do not comply with one or more of the following conditions can be removed:

Customer name: missing

Customer address: missing

Contract term: <12 months or a predetermined maximum period

Due date: missing

Due date >30 days from invoice date

Contract period: anything other than monthly

Contract start date (for fixed-term contracts only) if contract has been in operation for >30 days

Current month's due date: already passed, with no payment made

Original contract amount: missing

Contract status: canceled, suspended, missing

Current month's payment status: past due x days

Ineligible recurring receivables contracts are discarded and nothing more is done with them. Eligible recurring receivables contracts are ingested and passed on to the steps described earlier in this application.

Discount Rate, Offer, & Repayment Dates

The system can automatically calculate discount rates for each RRR. Every RRR is assigned a discount rate based on the Funder's choice of discount rate in the Funder Parameters. Example: If the Funder's discount rate were 10.00%, that rate would be apply to each uploaded RRR, and each RRR would be proposed for funding at 90.00% of its total value.

The system can automatically calculate offers for each RRR. As previously noted, the Offer=(1−discount rate)*RRR annual amount. Example: 12-month RRR; $100/month=$1,200 per year; 10.0% discount=$120.00; offer=$1,080.00.

The system calculates initial repayment date for each RRR. The system identifies current due date for each RRR (for payments from the Buyer to the Seller). The system sets the end of the following month as the first repayment date (for payments from the Seller to the Buyer) Example: (1) Assume that the current due date for RRR #1234 is October 14; (2) The first repayment date is therefore the end of the next month (November), which—in November's case—would be November 30.

The system calculates subsequent repayment dates for each RRR. The system notes a first repayment date for each RRR. The system identifies the end of each of the next 11 months as the next 11 repayment dates. Example: (1) First repayment date is November 30; (2) Next 11 repayment dates would be: December 31, January 31 of the following year, February 28 (or 29 if a leap year) of the following year, March 31 of the following year, . . . October 31 of the following year

Retrieving Other Defined Values for Each RRR

The system can automatically retrieve the following values for each RRR:

Uploaded (upload date)—dd mmm yyyy, e.g., 1 Oct. 2021, left-justified.

RRR #(RRR contract number)—actual format, left-justified.

SuRF Score (if available) or N/A (if not available)—whole numbers only, no decimal digits, right-justified, e.g., 98; if SuRF Score is not available, N/A is centered.

Buyer Name—actual format, left-justified

Ccy (currency)—three-letter abbreviation, left-justified, e.g. USD.

Term—whole number, followed by “mos”, right-justified.

Mo Pymt (monthly payment)—numerals only, with commas and two decimal digits, right-justified, e.g., 1,000.00.

Annual Value—numerals only, with commas and two decimal digits, right-justified, e.g.

12,000.00.

Discount (from Funder Parameters)—percentage, two decimal digits, right-justified, e.g. 12.00%.

Offer (using calculations above)—numerals only, with commas and two decimal digits, right-justified, e.g. 10,560.00.

Due dates and repayment schedule (using calculations above)—(1) for dates: dd mmm yyyy, e.g., 1 Oct. 2021, left-justified; (2) for repayment amounts: Ccy+Mo Pymt, as described above.

Fundable & Queue Database Tables

A discussed previously, fundable and non-fundable groups can be stored in a variety of different data structures. In an exemplary embodiment, the fundable group and non-fundable groups are database tables that include the details of all RRRs that are members of each of the Fundable

Group and a Non-fundable Queue/Group.

Each of the two database tables can include all of the RRRs and can have the following contents/columns:

Posted (posted date)

Offer #

SuRF

Buyer

Term

Ccy (Currency)

Mo Pymt (monthly payment)

Receivable Amt (receivable amount)

Offer

Disc (discount rate)

Expires (time until offer expires)

Status (in offer or queue)

Content format: The format of and any differences in the database tables' content is shown below.

| Column | | | Fundable | Non-fundable |
|---|---|---|---|---|
| Header | Format | | Group | Queue |
| Posted | 21 Sep. 2021 | | Same | |
| Offer # | #s and letters | | Offer # | N/A |
| SuRF | 90 | | Same | |
| Buyer | Buyer's name | | Same | |
| Term | 12 | mos | Same | |
| Ccy | USD | | Same | |
| Mo Pymt | 999,999.00 | | Same | |
| Receivable | 9,000,000,000.00 | | Same | |
| Amt | | | | |
| Offer | 8,100,000.000.00 | | Same | |
| Disc | 10.00% | | Same | |
| Expires | 30 | minutes | Time starts when | N/A |
| | | | offer is up | |

| | | | |
|---|---|---|---|
| Status | Offer | Offer | Queue |

Offer #. The offer number is created and can have the format as shown below:

CR01AD0001-211009-01, where:

CR: The first two letters of the Funder's name.

01: Ordinal number of Funder in the specific alphabetic code; for instance, CR12 represents the 12th Funder whose name starts with “CR.”

AD: The first two letters of the Funder's name.

0001: Ordinal number of the Seller; assigned in same way as Funder's ordinal number.

-211009: Year (21), Month (10), and Date (09) in which the Offer was created.

-01: Ordinal number of the offer on the date noted; e.g., “05” is the fifth offer for the given combination of Funder and Seller on the date specified.

Presenting offers on a Seller Offer Screen

The Offer Screen is based on the Funder's Fundable Group, just created. The Offer Screen includes the following elements in the Funding Offer to the Seller:
Total funding available
Total receivables value
Number of receivables included
Maximum duration of funding
An “Offer Expires In” indicator, with the number of hours and minutes remaining until the Offer expires
An “Accept Offer” button (if the Offer is currently active the “Accept” and “Refresh” buttons live in the same location and only one appears at a time)
A “Refresh Offer” button (if the Offer is expired; the “Accept” and “Refresh” buttons live in the same location and only one appears at a time)
A “View Offer Details” link
Seller-adjustable parameters for the amount of the offer and the maximum duration of the offer.
An “Update Offer” button within the Seller-adjustable parameters pane

The summary elements of the Offer are calculated in this way:
“Total Funding Available” is the sum of all of the offer (funding) amounts in the Fundable Group database table, as described previously.
“Total Receivables Value” is the sum of all of the receivable amounts in the Fundable Group database table.
“Discount Rate” is (1−Funding/Total Receivables Value).
“Number of Receivables Included” is the total number of receivables listed in the Fundable Group database table.
“Maximum Duration” represents the longest funding term (period of time) among all of the receivables listed in the Fundable Group database table.

The Seller has five options when presented with the Offer Screen:

Option 1: Click the “Accept Offer” button. Once the Seller clicks the “Accepts Offer” button, a confirmation modal appears. If the Seller confirms, the following actions take place: (1) The Offer Screen is replaced by the Seller's Repayment Screen (described later on); (2) The accepted receivables populate both the Seller's and Funder's Repayment Screens; (3) The funding process begins, as currently happens. Note that once an Offer is accepted by a Seller, the “Fundable Group” is renamed the “Funded Group” (previously called the “Offer Group”). The RRRs in the Funded Group are the same as in the Fundable Group; the only difference is that the Offer on the Fundable Group is accepted and its RRRs funded.

Option 2: Click the “Refresh Offer” button. If an Offer expires, as described below (or if no Offer has been requested), the Seller clicks the “Refresh Offer” button in order to generate a new or initial Offer. If no Offer is currently active, the summary elements described above are zeroed out and grayed out. When the “Refresh Offer” button is clicked, an Offer is created following the process described in Step 3 and moving forward. The actions required to create the new Offer are as follows: (1) Stripe. System automatically checks Stripe to see if there are any new receivables present in Stripe that have not previously been uploaded and uploads and validates them. (2) Queue Check. System automatically checks the RRRs in the Queue to ensure that they are still compliant with the requirements in Step 5. Any that are not still compliant are removed from the Queue. (Note: once an Offer expires, all of the RRRs included in the Offer are sent to the Queue, along with RRRs that were previously in the Queue.). (3) Combining. System automatically combines the RRRs remaining in the Queue with any newly uploaded RRRs. (4) Offer-Creation Process. Using this combined set of RRRs as the base, the System proceeds to undertake Steps 7 through 10 in order to create a new Offer. Once created, the new Offer is presented on the Offer Screen. The “Refresh Offer” button changes (or changes back) to “Accept Offer” button. The Seller then has the same options as described in this step. Note that the new Offer may differ from the previous Offer (i.e., the Offer being refreshed) if conditions have changed (for instance, if an Offer is no longer eligible, if the Funder has changed its overall exposure limit, or if the amount of the Funder's current exposure has changed.

Option 3: Click the “View Offer Details” link. If an active Offer is present, the Seller can click the “View Offer Details” link. The click opens an “Offer Details” overlay that provides a scrollable list of all of the RRRs included in the current Offer. The “Offer Details” overlay lists the Offer # in the overlay title and includes these columns: Posted (posted date), RRR #(ID # of the contract itself), SuRF, Buyer, Term, Ccy (Currency), Mo Pymt (monthly payment), Receivable Amt (receivable amount), Offer, Disc (discount rate), All [x] (the content of each row in this column is a checkbox). The RRRs on the “Offer Details” overlay are listed in declining-offer-value order, with RRRs with the highest monetary-offer-value being listed first, down to those with the lowest monetary-offer-value. Within a given monetary-offer-value, the RRRs are listed in random order. For instance, all of the Offers with a total monetary-offer-value of $2,700.00 might be listed first, followed by those with a total monetary-offer-value of $1,800.00, followed by those with a total monetary-offer-value of $900.00.

The Seller can take any of three actions:

Close the “Offer Details” overlay to proceed, whether or not any unchecking or rechecking of checkboxes has occurred (see below). If the “Offer Details” overlay is simply closed in this manner, no changes are made to the Offer.

Uncheck or recheck the right-side column checkbox for any of the RRRs (rows) in the “Offer Details” overlay. (1) The “All” checkbox and all of the individual checkboxes are checked by default. (2) Unchecking the “All” checkbox unchecks all of the individual checkboxes. (3) Rechecking the “All” checkbox rechecks each of the individual checkboxes. (4) Unchecking any of the individual checkboxes unchecks the “All” checkbox if it is currently checked. (5) Clicking a checked checkbox unchecks it and vice-versa.

Click the “Update Offer” button at the bottom of the overlay. This button is grayed out and not clickable unless changes have been made in the checkboxes. If the “Update Offer” button is clicked, the overlay closes and the Offer Screen elements are updated, where relevant.

Option 4: Adjust and update the Offer by changing parameters. The Seller can adjust two Offer parameters: (1) the amount of the offer; and (2) the maximum duration of the offer. These changes are implemented via the sliders or dials adjacent to the two parameters in the Seller-adjustable parameters pane.

How the Amount slider/dial works:

The range of the Amount slider/dial is from: (1) zero; to (2) the total amount of the Offer.

As the slider/dial is turned down, the RRRs on the Offer Details overlay (not visible when the slider/dial is being adjusted) are gradually unchecked, with the RRRs with the smallest offers (those at the bottom of the Offer Details overlay) being unchecked first.

The RRRs are unchecked so that the total Offer Amount among still-checked RRRs is less than or equal to the amount on the dial.

For instance, if there are five RRRs in the Offer with total monetary-offer-values of: $2,700.00, $2,700.00, $1,800.00, $900.00, and $900.00 (total Offer value of $9,000.00):

Turning the slider/dial to $8,500.00 would uncheck one of the $900.00 RRRs (leaving a total Offer value of $8,100.00, which is the largest value less than the $8,500.00 on the slider/dial);

Turning the slider/dial to $8,000.00 would uncheck the other $900.00 RRR (leaving a total Offer value of $7,200.00, which is the largest value less than the $8,000.00 on the slider/dial);

Turning the slider/dial to $7,500.00 would no effect (since $7,200.00 is still below $7,500.00);

Turning the slider/dial to $7,000.00 would uncheck the $1,800.00 RRR (leaving a total Offer value of $5,400.00, which is the largest value less than the $7,000.00 on the slider/dial); and so on.

How the Duration slider/dial works:

The range of the Duration slider/dial is from: (1) zero; to (2) the longest term (in months) represented among all of the RRRs in the Offer.

As the slider/dial is turned down, the RRRs on the Offer Details overlay (not visible when the slider/dial is being adjusted) are gradually unchecked, with those whose term (in months) is greater than the maximum selected on the slider/dial being unchecked.

For instance, if there are nine RRRs in the Offer Details overlay, with three each at terms of 12 months, 9 months, and 6 months:

Turning the slider/dial down to 11 months would uncheck the three 12-month-term RRRs;

Turning the slider/dial down to 10 months and then on to 9 months would have no effect.

Turning the slider/dial down to 8 months would uncheck the three 9-month-term RRRs;

Turning the slider/dial down to 7 months and then on to 6 months would have no effect; and so on.

When the Seller clicks “Update Offer,” the Offer's summary elements update:

Total Funding Available

Total Receivables Value

Discount Rate

Number of Receivables Includes

Maximum Duration

The “Offer Details” overlay also updates. The unchecked RRRs are grayed out but clickable. They remain on the “Offer Details” overlay until the Seller clicks “Accept Offer” or the Offer expires. Only at that point, do the unchecked items go to the Queue.

Option 5: Leave the page or do nothing. If the Seller does nothing after the Offer is presented, the Offer will eventually expire. Visiting the Offer Screen when there is a currently active Offer starts the clock and causes the “Offer Expires” indicator to begin the countdown, with the time remaining changing with each passing minute. The clock's countdown continues even if the Seller leaves the Offer Screen. The clock's countdown also continues even if the Seller has made changes in the “Offer Details” overlay but takes no action. If, having left the Offer Screen, the Seller returns, then one of two things happen:
If the Offer has not expired, the Offer is still present on the screen with the “Offer Expires In” indicator continue to countdown from the then-current time remaining.
If the Offer has expired, all of the Offer elements, where relevant, will have returned to zero, and the Offer Screen's contents will be grayed out except for the “Refresh Offer” button.

If the Offer has expired, all of the RRRs in the Offer move to the Queue and the Offer has to be refreshed, as described above, in order to generate a new Offer. Note that the Seller's “Offer” Screen and “Offer Details” overlay replace the two Seller Receivables screens, which are essentially combined on the “Offer Details” overlay.

Funder Funds RRRs Selected by Seller

When the Seller Accepts an Offer, the normal funding process begins. In addition, as also noted above, when the Seller accepts an Offer, the RRRs go directly to the Seller's and Funder's Repayment Screens, as described below. There is no need for the Funder's Receivables Screen.

Automatic Forwarding of Funded RRRs to Repayment Screens

RRRs can move to the Seller and Funder Repayment Screens simultaneously, and remain on these screens until either the RRR is canceled or otherwise becomes unacceptable and is replaced, or the funding for the RRR is fully repaid. At that time, the RRRs move to their respective History screens.

Sections for Each Repayment Screen

Offers. The list of Offers, which, for both Sellers and Funders, appears on the main Repayment screen. The list of Offers includes only the Offer groups.

Individual RRRs. Clicking on any Offer # in the Seller or Funder Repayment Screen opens a Repayment Details Overlay, which is similar to the Offer Details Overlay described in Step 12.

Replacements

Within either the Repayment Screens or the Repayment Details Overlays (for both Sellers and Funders), if an RRR has been automatically replaced (substituted for), that information is presented in the respective Repayment History & Schedule modals (i.e., all RRRs within a given substitution path are listed on the both Seller and Funder modals in order and with dates of coverage).

If an RRR is replaced, the new RRR # shows up on both the Seller's and the Funder's respective Receivables Details Overlays.

Making Repayments

Seller repayments can be made only on the main Seller Repayment Screen but not from the Seller's Repayment Details Overlay

Seller must make entire payment—cannot pay individual receivable obligations

Same Seller repayment amount is due regardless of whether RRR substitutions took place

All Seller repayments are due the end of each month

When a Seller repayment is made:

All Payment Due Dates are automatically updated on both Seller & Funder Repayment Screens and Repayment Details Overlays

All Seller and Funder Repayment History & Schedule modals are updated, where relevant

Any Payment Due amounts that have changed in a given month (because shorter-term RRRs, e.g., six-month, have been repaid while longer-term RRRs, e.g., 12-month, have balances still due) are automatically updated on both Seller & Funder Repayment Screens and Repayment Details Overlays and all Seller and Funder Repayment History & Schedule modals

If a particular RRR within an Offer is fully repaid but other RRRs in the offer still have balances due, all RRRs (including those that have been fully repaid) remain on the Seller and Funder Repayment Overlays and do not move to the Seller and Funder History Details Overlays until all RRRs within the Offer have ben fully repaid.

An Offer and all of its constituent RRRs automatically move from the Seller and Funder Repayment Screens & Overlays and onto the Seller and Funder History Screens & Overlays as soon as all RRRs within the Offer have been fully repaid.

Funder Contacts

The Funder can contact the Seller from within the Funder's Repayment Screen but not from within the Funder's Repayment Details Overlay.

No actions can be taken from within the Funder's Repayment Details Overlay

Automatic Forwarding of Repaid RRRs to History Screens

RRRs move to the Seller and Funder History Screens simultaneously, as part of their Funded Group when the financing for the Funded Group is fully repaid. Prior to this full repayment, all RRRs—including those that have been removed from the Funded Group—remain on the respective Repayment Screens. Once having moved to the History Screens, the Funded Group and all of its constituent RRRs (including “removed” RRRs) remain there permanently.

The structure (but not the content) of the History Screens is identical to that of the Repayment Screens:
Offers. As with the Repayment Screens, there are two sections for each History Screen: the list of Offers, which, for both Sellers and Funders, is the main History screen. The list of Offers includes only the Offer groups.
Individual RRRs. Clicking on any Offer group row opens the History Details overlay, which is similar to the Offer Details overlay described in Step 12 and to the Repayment Details overlay described in Step 13.

Replacements

As with the respective Repayment Screens, within either the History Screens or the History Details Overlays (for both Sellers and Funders), if an RRR has been automatically replaced (substituted for), that information is presented in the respective Repayment History & Schedule modals (i.e., all RRRs within a given substitution path are listed on the both Seller and Funder modals in order and with dates of coverage).

If an RRR is replaced, the new RRR # shows up on both the Seller's and the Funder's respective Receivables Details Overlays.

Post-Sale Period—Checking for No-Longer-Eligible RRRs

For Each RRR Payment Due During Month N:
The system automatically checks Stripe at the end of Month N+1 for RRR eligibility
Any RRRs that remain eligible are preserved in the respective Monthly Payment Group (MPG)
Any RRRs that are ineligible are replaced in the respective Monthly Payment Group by matching RRRs from the Queue

Following is the Full Eligibility-Check Process:

Definition: no-longer-eligible RRRs include RRRs that are canceled, suspended, or unpaid (i.e., any RRRs that are not marked as “Paid”) on morning of the end-of-the-month repayment due date.

System checks for no-longer eligible RRRs in the Seller's Offer Group and the Seller's Queue.

System counts the number of no-longer eligible RRRs in each MPG the Seller's Offer Group.

System removes no-longer-eligible RRRs from the Seller's Offer Queue and the Seller's Queue.

System replaces no-longer-eligible RRRs in each of the MPGs in the Seller's Offer Group with active RRRs from the same MPG in the Seller's Queue.

System updates Seller & Funder Repayment screens with removed and added RRRs.

Seller Monthly Payment

Each month, the seller makes its monthly repayment. The Seller can click to open Repayment Details modal to view individual RRRs due for repayment. The Seller clicks to make monthly repayment, using standard repayment process. The Seller clicks repayment-confirmation modal.

If repayment date arrives, due dates on Seller & Funder Repayment Screens and Repayment Details modals turn green. If repayment is past due, due dates on Seller & Funder Repayment Screens and Repayment Details modals turn red

After repayment is made, due dates are updated on Seller and Funder Repayment Screens and Repayment Details modals and they return to their original color and due dates and repayments are updated on Repayment Schedule modals.

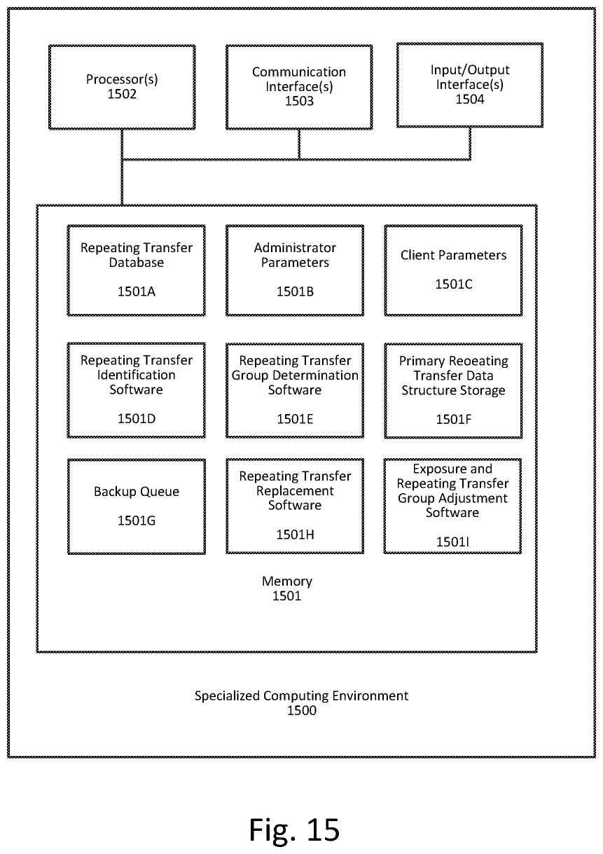

FIG. 15 illustrates the components of the specialized computing environment 1500 configured to perform the specialized processes described herein. Specialized computing environment 1500 is a computing device that includes a memory 1501 that is a non-transitory computer-readable medium and can be volatile memory (e.g., registers, cache, RAM), non-volatile memory (e.g., ROM, EEPROM, flash memory, etc.), or some combination of the two.

As shown in FIG. 15, memory 1501 can include repeating transfer database 1501A, administrator parameters 1501B, client (e.g., funder) parameters 1501C, primary (e.g., fundable) and backup (e.g., non-fundable) repeating transfer identification software 1501D, repeating transfer group (e.g., MPG) determination software 1501E, primary repeating transfer data structure (e.g., fundable contract) storage 1501F, backup (e.g., non-fundable) queue 1501G, repeating transfer (e.g., RRR contract) replacement software 1501H, exposure and repeating transfer group adjustment software 1501I. Each of the software components in memory 1501 store specialized instructions and data structures configured to perform the corresponding functionality and techniques described herein.

All of the software stored within memory 1501 can be stored as a computer-readable instructions, that when executed by one or more processors 1502, cause the processors to perform the functionality described with respect to FIGS. 1-14.

Processor(s) 1502 execute computer-executable instructions and can be a real or virtual processors. In a multi-processing system, multiple processors or multicore processors can be used to execute computer-executable instructions to increase processing power and/or to execute certain software in parallel.

Specialized computing environment 1500 additionally includes a communication interface 1503, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 1500 further includes input and output interfaces 1504 that allow users (such as system administrators) to provide input to the system to set parameters, to edit data stored in memory 1501, or to perform other administrative functions.

An interconnection mechanism (shown as a solid line in FIG. 15), such as a bus, controller, or network interconnects the components of the specialized computing environment 1500.

Input and output interfaces 1504 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 1500.

Specialized computing environment 1500 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 1500.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure.

1. A method executed by one or more computing devices of a controller of a transfer network for dynamic substitution of repeating transfer data structures using a linked queue, the method comprising:
grouping a plurality of repeating transfer data structures into a plurality of repeating transfer groups according to a term parameter of each repeating transfer data structure and a transfer quantity parameter of each repeating transfer data structure, each repeating transfer group corresponding to a set of repeating transfer data structures having the same term parameter and transfer quantity parameter;
identifying a plurality of primary repeating transfer data structures and a plurality of backup repeating transfer data structures in each repeating transfer group based at least in part on a utilization ratio;
storing the plurality of primary repeating transfer data structures in the plurality of repeating transfer groups in a plurality of primary groups in a memory of at least one of the one or more computing devices and storing the plurality of backup repeating transfer data structures in the plurality of repeating transfer groups in a plurality of backup queues in the memory, wherein each backup queue corresponding to a repeating transfer group is linked in the memory to a primary group corresponding to the same repeating transfer group;
detecting failure of a primary repeating transfer data structure in a first primary group corresponding to a first repeating transfer group in the plurality of repeating transfer groups; and
in response to detecting failure of the primary repeating transfer data structure, removing the failed primary repeating transfer data structure from the first primary group and substituting a backup repeating transfer data structure from a first backup queue corresponding to the first repeating transfer group and linked in the memory to the first primary group into the first primary group.

2. The method of claim 1, further comprising:
filtering the plurality of repeating transfer groups to remove any repeating transfer groups having a quantity of repeating transfer data structures below a minimum threshold prior to identifying a plurality of primary repeating transfer data structures and a plurality of backup repeating transfer data structures in each repeating transfer group.

3. The method of claim 1, further comprising:
determining a total value of repeating transfer data structures for each primary group in the plurality of primary groups based at least in part on the term parameter of each repeating transfer data structure in the primary group and the transfer quantity parameter of each repeating transfer data structure in the primary group; and
determining a total transfer quantity for each primary group in the plurality of primary groups based at least in part on the total transfer quantity for the primary group and network-client adjustments associated with repeating transfer data structures in each primary group.

4. The method of claim 3, further comprising:
transferring one or more repeating transfer data structures in one or more primary groups in the plurality of primary groups from the one or more primary groups to one or more backup queues in the plurality of backup queues that are linked to the one or more primary groups based at least in part on a transfer exposure limit.

5. The method of claim 4, wherein transferring one or more repeating transfer data structures in one or more primary groups in the plurality of primary groups from the one or more primary groups to one or more backup queues in the plurality of backup queues that are linked to the one or more primary groups based at least in part on a transfer exposure limit comprises:
determining an aggregate total transfer quantity for the plurality of primary groups as the sum of the total transfer quantity for each primary group in the plurality of primary groups;
determining whether the aggregate total transfer quantity exceeds the transfer exposure limit; and
transferring the one or more repeating transfer data structures in the one or more primary groups from the one or more primary groups to the one or more backup queues that are linked to the one or more primary groups based at least in part on a determination that the aggregate total transfer quantity exceeds the transfer limit.

6. The method of claim 5, wherein transferring the one or more repeating transfer data structures in the one or more primary groups from the one or more primary groups to the one or more backup queues that are linked to the one or more primary groups based at least in part on a determination that the aggregate total funding amount exceeds the transfer exposure limit comprises:
iteratively removing the one or more repeating transfer data structures in the one or more primary groups from the one or more primary groups until an updated aggregate total transfer quantity of the remaining repeating transfer data structures in the plurality of primary groups is less than or equal to the transfer exposure limit; and
transferring the removed one or more repeating transfer data structures to the one or more backup queues that are linked to the one or more primary groups.

7. The method of claim 6, wherein iteratively removing the one or more repeating transfer data structures in the one or more primary groups from the one or more primary groups until an updated aggregate total transfer quantity of the remaining repeating transfer data structures in the plurality of primary groups is less than or equal to the transfer exposure limit comprises:
removing repeating transfer data structures having higher total transfer quantities prior to removing repeating transfer data structures having lower total transfer quantities, wherein the total transfer quantity for each individual repeating transfer data structures is determined as the product of the term parameter and the transfer quantity parameter.

8. The method of claim 4, further comprising:
determining a total proposed transfer quantity based at least in part on the remaining repeating transfer data structures in the plurality of primary groups.

9. The method of claim 1, wherein identifying a plurality of primary repeating transfer data structures and a plurality of backup repeating transfer data structures in each repeating transfer group based at least in part on a utilization ratio comprises, for each repeating transfer group:
determining a first quantity of possible primary repeating transfer data structures for the repeating transfer group based at least in part on the utilization ratio and a total quantity of repeating transfer data structures in the repeating transfer group;
determining a second quantity of possible backup repeating transfer data structures for the repeating transfer group based at least in part on the first quantity of primary repeating transfer data structures and the total quantity of repeating transfer data structures in the repeating transfer group;
designating a third quantity of repeating transfer data structures in the repeating transfer group as backup repeating transfer data structures, the third quantity being equal to the second quantity; and
designating any remaining repeating transfer data structures in the repeating transfer group as primary repeating transfer data structures.

10. A controller of a transfer network for dynamic substitution of repeating transfer data structures using a linked queue, the controller comprising:
one or more processors; and
one or more memories operatively coupled to at least one of the one or more processors and having instructions stored thereon that, when executed by at least one of the one or more processors, cause at least one of the one or more processors to:
group a plurality of repeating transfer data structures into a plurality of repeating transfer groups according to a term parameter of each repeating transfer data structure and a transfer quantity parameter of each repeating transfer data structure, each repeating transfer group corresponding to a set of repeating transfer data structures having the same term parameter and transfer quantity parameter;
identify a plurality of primary repeating transfer data structures and a plurality of backup repeating transfer data structures in each repeating transfer group based at least in part on a utilization ratio;
store the plurality of primary repeating transfer data structures in the plurality of repeating transfer groups in a plurality of primary groups in a memory of at least one of the one or more computing devices and storing the plurality of backup repeating transfer data structures in the plurality of repeating transfer groups in a plurality of backup queues in the memory, wherein each backup queue corresponding to a repeating transfer group is linked in the memory to a primary group corresponding to the same repeating transfer group;
detect failure of a primary repeating transfer data structure in a first primary group corresponding to a first repeating transfer group in the plurality of repeating transfer groups; and
in response to detecting failure of the primary repeating transfer data structure, remove the failed primary repeating transfer data structure from the first primary group and substituting a backup repeating transfer data structure from a first backup queue corresponding to the first repeating transfer group and linked in the memory to the first primary group into the first primary group.

11. The controller of claim 10, wherein at least one of the one or more memories has further instructions stored thereon that, when executed by at least one of the one or more processors, cause at least one of the one or more processors to:
filter the plurality of repeating transfer groups to remove any repeating transfer groups having a quantity of repeating transfer data structures below a minimum threshold prior to identifying a plurality of primary repeating transfer data structures and a plurality of backup repeating transfer data structures in each repeating transfer group.

12. The controller of claim 10, wherein at least one of the one or more memories has further instructions stored thereon that, when executed by at least one of the one or more processors, cause at least one of the one or more processors to:
determine a total value of repeating transfer data structures for each primary group in the plurality of primary groups based at least in part on the term parameter of each repeating transfer data structure in the primary group and the transfer quantity parameter of each repeating transfer data structure in the primary group; and
determine a total transfer quantity for each primary group in the plurality of primary groups based at least in part on the total transfer quantity for the primary group and network-client adjustments associated with repeating transfer data structures in each primary group.

13. The controller of claim 12, wherein at least one of the one or more memories has further instructions stored thereon that, when executed by at least one of the one or more processors, cause at least one of the one or more processors to:
transfer one or more repeating transfer data structures in one or more primary groups in the plurality of primary groups from the one or more primary groups to one or more backup queues in the plurality of backup queues that are linked to the one or more primary groups based at least in part on a transfer exposure limit.

14. The controller of claim 13, wherein the instructions that, when executed by at least one of the one or more processors, cause at least one of the one or more processors to transfer one or more repeating transfer data structures in one or more primary groups in the plurality of primary groups from the one or more primary groups to one or more backup queues in the plurality of backup queues that are linked to the one or more primary groups based at least in part on a transfer exposure limit further cause at least one of the one or more processors to:
determine an aggregate total transfer quantity for the plurality of primary groups as the sum of the total transfer quantity for each primary group in the plurality of primary groups;
determine whether the aggregate total transfer quantity exceeds the transfer exposure limit; and
transfer the one or more repeating transfer data structures in the one or more primary groups from the one or more primary groups to the one or more backup queues that are linked to the one or more primary groups based at least in part on a determination that the aggregate total transfer quantity exceeds the transfer limit.

15. The controller of claim 14, wherein the instructions that, when executed by at least one of the one or more processors, cause at least one of the one or more processors to transfer the one or more repeating transfer data structures in the one or more primary groups from the one or more primary groups to the one or more backup queues that are linked to the one or more primary groups based at least in part on a determination that the aggregate total funding amount exceeds the transfer exposure limit further cause at least one of the one or more processors to:
iteratively remove the one or more repeating transfer data structures in the one or more primary groups from the one or more primary groups until an updated aggregate total transfer quantity of the remaining repeating transfer data structures in the plurality of primary groups is less than or equal to the transfer exposure limit; and
transfer the removed one or more repeating transfer data structures to the one or more backup queues that are linked to the one or more primary groups.

16. The controller of claim 15, wherein the instructions that, when executed by at least one of the one or more processors, cause at least one of the one or more processors to iteratively remove the one or more repeating transfer data structures in the one or more primary groups from the one or more primary groups until an updated aggregate total transfer quantity of the remaining repeating transfer data structures in the plurality of primary groups is less than or equal to the transfer exposure limit further cause at least one of the one or more processors to:
remove repeating transfer data structures having higher total transfer quantities prior to removing repeating transfer data structures having lower total transfer quantities, wherein the total transfer quantity for each individual repeating transfer data structures is determined as the product of the term parameter and the transfer quantity parameter.

17. The controller of claim 14, wherein at least one of the one or more memories has further instructions stored thereon that, when executed by at least one of the one or more processors, cause at least one of the one or more processors to:
determine a total proposed transfer quantity based at least in part on the remaining repeating transfer data structures in the plurality of primary groups.

18. The controller of claim 10, wherein the instructions that, when executed by at least one of the one or more processors, cause at least one of the one or more processors to identify a plurality of primary repeating transfer data structures and a plurality of backup repeating transfer data structures in each repeating transfer group based at least in part on a utilization ratio further cause at least one of the one or more processors to, for each repeating transfer group:
determine a first quantity of possible primary repeating transfer data structures for the repeating transfer group based at least in part on the utilization ratio and a total quantity of repeating transfer data structures in the repeating transfer group;
determine a second quantity of possible backup repeating transfer data structures for the repeating transfer group based at least in part on the first quantity of primary repeating transfer data structures and the total quantity of repeating transfer data structures in the repeating transfer group;
designate a third quantity of repeating transfer data structures in the repeating transfer group as backup repeating transfer data structures, the third quantity being equal to the second quantity; and
designate any remaining repeating transfer data structures in the repeating transfer group as primary repeating transfer data structures.

19. At least one non-transitory computer-readable medium storing computer-readable instructions for dynamic substitution of repeating transfer data structures using a linked queue that, when executed by one or more computing devices of a controller of a transfer network, cause the controller to:
group a plurality of repeating transfer data structures into a plurality of repeating transfer groups according to a term parameter of each repeating transfer data structure and a transfer quantity parameter of each repeating transfer data structure, each repeating transfer group corresponding to a set of repeating transfer data structures having the same term parameter and transfer quantity parameter;
identify a plurality of primary repeating transfer data structures and a plurality of backup repeating transfer data structures in each repeating transfer group based at least in part on a utilization ratio;
store the plurality of primary repeating transfer data structures in the plurality of repeating transfer groups in a plurality of primary groups in a memory of at least one of the one or more computing devices and storing the plurality of backup repeating transfer data structures in the plurality of repeating transfer groups in a plurality of backup queues in the memory, wherein each backup queue corresponding to a repeating transfer group is linked in the memory to a primary group corresponding to the same repeating transfer group;
detect failure of a primary repeating transfer data structure in a first primary group corresponding to a first repeating transfer group in the plurality of repeating transfer groups; and
in response to detecting failure of the primary repeating transfer data structure, remove the failed primary repeating transfer data structure from the first primary group and substituting a backup repeating transfer data structure from a first backup queue corresponding to the first repeating transfer group and linked in the memory to the first primary group into the first primary group.

20. The at least one non-transitory computer-readable medium of claim 19, further storing computer-readable instructions that, when executed by the controller, cause the controller to:
filter the plurality of repeating transfer groups to remove any repeating transfer groups having a quantity of repeating transfer data structures below a minimum threshold prior to identifying a plurality of primary repeating transfer data structures and a plurality of backup repeating transfer data structures in each repeating transfer group.

21. The at least one non-transitory computer-readable medium of claim 19, further storing computer-readable instructions that, when executed by the controller, cause the controller to:
determine a total value of repeating transfer data structures for each primary group in the plurality of primary groups based at least in part on the term parameter of each repeating transfer data structure in the primary group and the transfer quantity parameter of each repeating transfer data structure in the primary group; and
determine a total transfer quantity for each primary group in the plurality of primary groups based at least in part on the total transfer quantity for the primary group and network-client adjustments associated with repeating transfer data structures in each primary group.

22. The at least one non-transitory computer-readable medium of claim 21, further storing computer-readable instructions that, when executed by the controller, cause the controller to:
transfer one or more repeating transfer data structures in one or more primary groups in the plurality of primary groups from the one or more primary groups to one or more backup queues in the plurality of backup queues that are linked to the one or more primary groups based at least in part on a transfer exposure limit.

23. The at least one non-transitory computer-readable medium of claim 22, wherein the instructions that, when executed by the controller, cause the controller to transfer one or more repeating transfer data structures in one or more primary groups in the plurality of primary groups from the one or more primary groups to one or more backup queues in the plurality of backup queues that are linked to the one or more primary groups based at least in part on a transfer exposure limit further cause the controller to:
determine an aggregate total transfer quantity for the plurality of primary groups as the sum of the total transfer quantity for each primary group in the plurality of primary groups;
determine whether the aggregate total transfer quantity exceeds the transfer exposure limit; and
transfer the one or more repeating transfer data structures in the one or more primary groups from the one or more primary groups to the one or more backup queues that are linked to the one or more primary groups based at least in part on a determination that the aggregate total transfer quantity exceeds the transfer limit.

24. The at least one non-transitory computer-readable medium of claim 23, wherein the instructions that, when executed by the controller, cause the controller to transfer the one or more repeating transfer data structures in the one or more primary groups from the one or more primary groups to the one or more backup queues that are linked to the one or more primary groups based at least in part on a determination that the aggregate total funding amount exceeds the transfer exposure limit further cause the controller to:
iteratively remove the one or more repeating transfer data structures in the one or more primary groups from the one or more primary groups until an updated aggregate total transfer quantity of the remaining repeating transfer data structures in the plurality of primary groups is less than or equal to the transfer exposure limit; and
transfer the removed one or more repeating transfer data structures to the one or more backup queues that are linked to the one or more primary groups.

25. The at least one non-transitory computer-readable medium of claim 24, wherein the instructions that, when executed by the controller, cause the controller to iteratively remove the one or more repeating transfer data structures in the one or more primary groups from the one or more primary groups until an updated aggregate total transfer quantity of the remaining repeating transfer data structures in the plurality of primary groups is less than or equal to the transfer exposure limit further cause the controller to:
remove repeating transfer data structures having higher total transfer quantities prior to removing repeating transfer data structures having lower total transfer quantities, wherein the total transfer quantity for each individual repeating transfer data structures is determined as the product of the term parameter and the transfer quantity parameter.

26. The at least one non-transitory computer-readable medium of claim 23, further storing computer-readable instructions that, when executed by the controller, cause the controller to:
determine a total proposed transfer quantity based at least in part on the remaining repeating transfer data structures in the plurality of primary groups.

27. The at least one non-transitory computer-readable medium of claim 19, wherein the instructions that, when executed by the controller, cause the controller to identify a plurality of primary repeating transfer data structures and a plurality of backup repeating transfer data structures in each repeating transfer group based at least in part on a utilization ratio further cause the controller to, for each repeating transfer group:
determine a first quantity of possible primary repeating transfer data structures for the repeating transfer group based at least in part on the utilization ratio and a total quantity of repeating transfer data structures in the repeating transfer group;
determine a second quantity of possible backup repeating transfer data structures for the repeating transfer group based at least in part on the first quantity of primary repeating transfer data structures and the total quantity of repeating transfer data structures in the repeating transfer group;
designate a third quantity of repeating transfer data structures in the repeating transfer group as backup repeating transfer data structures, the third quantity being equal to the second quantity; and
designate any remaining repeating transfer data structures in the repeating transfer group as primary repeating transfer data structures.
